(19) United States
(12) Patent Application Publication
(10) Pub. No.: US 2007/0048666 A1
(43) Pub. Date: Mar. 1, 2007

(54) Two-photon recording method, two-photon absorption recording material, two-photon absorption recording-reproduction method and optical recoding medium

(75) Inventor: Hiroo Takizawa, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/510,656

(22) Filed: Aug. 28, 2006

(30) Foreign Application Priority Data
Aug. 26, 2005 (JP) P2005-246314

(51) Int. Cl. G03C 5/00

(52) U.S. Cl. 430/281.1; 430/138; 430/269

(57) ABSTRACT

A two-photon recording method is provided and includes: a first step of effecting two-photon absorption to form a latent image in a two-photon absorption recording material; a second step of subjecting the two-photon absorption recording material to heat treatment by which refractive index, absorptivity or luminescence intensity is modulated according to the latent image to effect recording; and a third step of irradiating the two-photon absorption recording material thus heat-treated with light on the entire surface thereof to fix the recording thus formed. The recording can be reproduced without being erased.

### BACKGROUND OF THE INVENTION

1. Field of the Invention

The present invention relates to a two-photon absorption recording material and a two-photon recording method which can be applied to high density optical recording media such as three-dimensional optical recording material three-dimensional volume displays, etc.

2. Description of Background Art

In general, nonlinear optical effect is nonlinear optical response proportional to the square, cube or higher power of the photoelectric field applied. In recent years, a three-dimensional nonlinear optical effect has been noted. In particular, nonresonant two-photon absorption has been noted. Two-photon absorption is a phenomenon that a compound absorbs two photons simultaneously to undergo excitation. The absorption of two photons in an energy region where there is no (linear) absorption band of the compound is called nonlinear two-photon absorption. The term “two-photon absorption” as used hereinafter is meant to indicate nonlinear two-photon absorption even if not particularly specified.

The efficiency of nonlinear two-photon absorption is proportional to the square of the photoelectric field applied (square properties of two-photon absorption). Therefore, when a two-dimensional plane is irradiated with laser light, two-photon absorption occurs only at a position having a high electric field on the central area of laser spot while no two-photon absorption occur at a surrounding portion having a weak electric field. On the other hand, in a three-dimensional space, two-photon absorption occurs only at a region having a high electric field on the focal point at which laser light is condensed through a lens while no two-photon absorption occur at regions deviated from the focal point because these regions have a weak electric field intensity. As compared with the linear absorption causing excitation at all positions in proportion to the intensity of the photoelectric field applied, the nonresonant two-photon absorption causes excitation only at one point in the space due to its square properties, making it possible to remarkably enhance the spatial resolution.

In general, in the case where nonresonant two-photon absorption is induced, laser light having a wavelength which is longer than the wavelength range where the (linear) absorption band of the compound is present and at which the compound shows no absorption is often used. The laser light used is in the transparent range and thus can reach the interior of the sample without being absorbed or scattered. Due to the square properties of nonresonant non-photon absorption, one point in the sample can be excited at an extremely high spatial resolution. This effect is of greater advantageous than normal one-photon (linear) absorption.

On the other hand, an optical data recording medium allowing only one recording of data with laser light (optical disc) has heretofore been known. Write-once-read-many type CD (so-called CD-R) and write-once-read-many type DVD (so-called DVD-R) have been put to practical use.

For example, a representative structure of DVD-R comprises a recording layer made of a dye, a light-reflecting layer normally provided on the recording layer and optionally a protective layer disposed on a transparent disc-shaped substrate having a guide groove (pre-groove) for tracking laser light incident thereon, the width of which guide grove is as narrow as not greater than half that of CD-R (0.74 μm to 0.8 μm).

The recording of data on DVD-R is carried out by irradiating DVD-R with visible laser light (normally having a wavelength of from 630 nm to 680 nm) so that the irradiated area on the recording layer absorbs the laser light to cause local temperature rise that leads to physical or chemical change (e.g., production of pits) resulting in the change of optical properties thereof. On the other hand, the reading (reproduction) of data is carried out by irradiating DVD-R with laser light having the same wavelength as that of the recording laser light. Data is reproduced by detecting the difference in reflectance between the position on the recording layer showing change of chemical properties (recorded position) and the position showing no change of chemical properties (unrecorded position). This difference in reflectance is based on so-called “modulation of refractive index”.

In recent years, networks such as internet and highvision TV have been rapidly spread. Further, with the operation of HDTV (high definition television) close at hand, there has been a growing demand for high density recording medium for simply recording image data having a capacity of 50 GB, preferably 100 GB or more at reduced cost also in consumers' use.

Further, an ultrahigh density recording medium capable of recording data having a capacity of about 1 TB or more at a high rate and reduced cost has been desired also in business uses such as computer backup and broadcast backup.

Under these circumstances, the related two dimensional optical recording media such as DVD-R can attain a recording capacity of 25 GB at maximum on one side even if the recording/reproducing wavelength is shifted to shorter range in physical principle and thus cannot be expected to provide a recording capacity great enough to cope with the future demand.

Under these circumstances, three-dimensional optical recording media have been suddenly noted as ultimate high density and high capacity recording media. A three-dimensional optical recording medium has recording stacked to scores to hundreds of layers in the three-dimensional (thickness) direction to attain recording density and capacity as ultrahigh as scores to hundreds of times that of the related art two-dimensional recording media. In order to provide a three-dimensional optical recording medium, arbitrary positions in the three-dimensional (thickness) direction must be accessed for writing. As such means them are a method involving the use of a two-photon absorption material and a method involving the use of holography (interference).

The three-dimensional optical recording medium comprising a two-photon absorption material allows so-called bit recording by scores to hundreds of times the related art technique on the basis of the physical principle described above and hence a higher density recording and thus can be regarded as ultimate high density and high capacity optical recording medium.

As the three-dimensional optical recording media comprising a two-photon absorption material, a method which comprises recording/reproducing of data with a fluorescent material and reading of data with fluorescence (Revitch, Eugene, Police et al., JP-T-2001-524245, Pabel, Eugene et al, JP-T-2000-512061), a method which comprises absorption with a photochromic compound or reading with fluorescence (Korotiev, Nikolai Ai et al, JP-T-2001-509221, Arsenov, Vlamir et al, JP-T-2001-508221), etc. have been proposed. However, none of these references propose specific two-photon absorption materials. Further, abstractly proposed examples of two-photon absorption compound include two-photon absorption compounds having an extremely small two-photon absorption efficiency. Moreover, the photochromic compound used in these references is a reversible material and thus leaves something to be desired in nondestructive reading, prolonged data storage properties, reproduction S/N ratio, etc. Therefore, these proposals cannot be, regarded as useful optical recording media.

From the standpoint of nondestructive reading and prolonged data storage properties in particular, it is preferred that an irreversible material be used to give a change of reflectance, transmittance (refractive index or absorptivity) or luminescence intensity by which reproduction is made. However, there have been no specific examples of two-photon absorption material having such a function.

Further, Satoru Kawata and Yoshimasa Kawata JP-A-6-28672 and Satoru Kawata and Yoshimasa Kawata, JP-A-6-118306 disclose a recording device for three-dimensionally recording data by refractive index modulation and a reproduction device and a reading method therefor. However, there is no reference to method using a two-photon absorption three-dimensional optima recording material.

Accordingly, in order to realized a two-photon absorption three-dimensional optical recording material or three-dimensional volume display, it is necessary that a two-photon recording method and a two-photon absorption recording material having a high sensitivity and excellent storage properties and allowing modulation of reflectance (refractive index), transmittance (absorptivity) or luminescence intensity be developed.

In general image recording methods, various dry type image recording methods involving no use of a liquid developer or other agents aid hence causing no generation of wastes have been heretofore studied. In particular, image recording methods involving the use of a photosetting composition have been noted. These image recording methods are characterized by a process which comprises exposing the recording material to light so that the photosetting composition contained in the recording material is cured to form a latent image while a component contained in the exposed area of the recording material which acts on color development or color extinction when heated moves through the interior of the recording material to form a color image. In the case where this type of a recording material is used, the recording material is exposed to light from laser or the like so that the exposed area is cured to form a latent image. The recording material is then heated so that the component contained in the uncured area (unexposed area) which acts on color development or color extinction moves to form a visible image. In accordance with this method, a full dry system causing no generation of wastes can be realized. For the details of these image recording methods, reference can be made to JP-A-2001-159825 and JP-A-2002-82431.

However, no examples of application of these image recording methods to two-photon recording method and two-photon absorption recording material have been described.

As mentioned above, when an excitation energy obtained by nonresonant two-photon absorption can be used to cause reaction by which refractive index, absorptivity or luminescence intensity is modulated at the laser-focused portion (recorded area) and the unfocused portion(non-recorded area), data can be recorded at arbitrary positions in a three-dimensional space at an extremely high spatial resolution, allowing application to the three-dimensional optical recording media, which are regarded as ultimate high density recording media.

However, the two-photon absorption compounds which can be used at present have a low two-photon absorptivity and thus require a very high output laser as light source and take much time to record data.

In order to use a two-photon absorption compound for three-dimensional optical recording media in particular, it is essential that a two-photon three-dimensional optical recording material allowing recording by two-photon absorption at a high sensitivity be established to attain a high transfer rate. To this end, a two-photon absorption compound which can absorb two photons at a high efficiency to produce excited state and a material containing a recording component which can form a difference in refractive index, absorptivity or luminescence intensity of two-photon absorption recording material using some method involving the use of excited state of two-photon absorption compound can be used to advantage. However, no such materials have been disclosed. It has been desired to establish such materials.

### SUMMARY OF THE INVENTION

An object of an illustrative, non-limiting embodiment of the invention is to provide a two-photon recording and reproducing method which comprises making refractive index-, absorptivity- or luminescence intensity-modulated recording in a recording material by the use of two-photon absorption, irradiating the recording material with light, and then detecting the resulting difference in reflectance, transmittance or luminescence intensity to effect reproduction and a two-photon absorption recording material allowing the recording/reproduction, Another object of an illustrative, non-limiting embodiment of the invention is to provide a two-photon absorption reproducing method and two-photon absorption recording material having a high sensitivity and excellent storage properties in particular.

A further object of an illustrative, non-limiting embodiment of the invention is to provide a two-photon absorption three-dimensional optical recording material and two-photon absorption three-dimensional recording method and reproduction method comprising such a material and method.

As a result of the inventors' extensive studies, the objects of the invention can be accomplished by the following constitutions.

(1) A two-photon recording method comprising the steps of:

a first step of forming a latent image in a two-photo absorption recording material by two-photon absorption;

a second step of subjecting the two-photon absorption recording material having the latent image to heat treatment so as to record a modulation of a refractive index, absorptivity or luminescence intensity in the two-photon absorption recording material in accordance with the latent image; and

a third step of irradiating the two-photon absorption recording material entirely with light to fix the modulation,

wherein a record can be reproduced based on the modulation without erasing the modulation.

(2) The two-photon recording method as defined in Clause 1, wherein a light source in the two-photon absorption of the first step is a laser.

(3) The two-photon recording method as defined in Clause 1 or 2, wherein a light source in the irradiating of the third step is at least one selected from the group consisting of a laser, an LED, a lash lamp, a fluorescent lamp, a xenon lamp and a mercury vapor lamp.

(4) The two-photon recording method as defined in any one of Clauses 1 to 3, wherein the two-photon absorption recording material comprises a photopolymerizable composition, the photopolymerizable composition comprising: a photopolymerizable compound having an ethylenically unsaturated bond; and a photopolymerization initiator.

(5) The two-photon recording method as defined in any one of Clauses 1 to 4, wherein the two-photon absorption recording material comprises a support and a photosensitive and thermosensitive recording layer comprising a photopolymerizable composition, the photopolymerizable composition comprising:
a thermo-responsive microcapsule containing a component a therein, the component A being one of a color-developable component and a color-extinguishable component;
a compound B that is substantially colorless, the compound B comprising, in the same molecule of the compound B, an ethylenically unsaturated bond and a site that reacts with the component A to cause color development or color extinction of the component A; and
a photopolymerizable initiator,
   and wherein

the photopolymerizable composition is subjected to the two-photon absorption at the first step to form die latent image,

the heat treatment at the second step causes color development or color extinction of the component A in accordance with the latent image to record the modulation of the refractive index, absorptivity or luminescence intensity, and
the photosensitive and thermosensitive recording layer is irradiated entirely with light at the third step to decolor the photopolymerization initiator so that the modulation is fixed.
   (6) The two-photon recording method as defined in any one of Clauses 1 to 4, wherein the two-photon absorption recording material comprises a support and a photosensitive and thermosensitive recording layer comprising a photopolymerizable composition, the photopolymerizable composition comprising:
a thermo-responsive microcapsule containing a component A therein, the component A being one of a color-developable component and a color-extinguishable component;
a component C that is substantially colorless and reacts with the component A to cause color development or color extinction of the component A;
a compound D comprising, in the same molecule of the compound B, an ethylenically unsaturated bond and a site that inhibits a reaction of the component C with the component A; and
a photopolymerizable initiator,
   and wherein

the photopolymerizable composition is subjected to the two-photon absorption at the first step to form the latent image,

the heat treatment at the second step causes color development or color extinction of the component A in accordance with the latent image to record the modulation of die refractive index, absorptivity or luminescence intensity, and

the photosensitive and thermosensitive recording layer is irradiated entirely with light at the third step to decolor the photopolymerization initiator so that the modulation is fixed.

(7) The two-photon recording method as defined in any one of Clauses 4 to 6, wherein the photopolymerization initiator comprises, a spectral sensitizing dye having a maximum absorption wavelength of 300 nm to 800 nm; and a compound interacting with the spectral sensitizing dye.

(8) The two-photon recording method as defied in Clause 7, wherein the spectral sensitizing dye is a compound undergoing two-photon absorption.

(9) The two-photon recording method as defined in Clause 7 or 8, wherein the two-photon absorption is induced by irradiating the two-photon absorption recording material with laser light having; a longer wavelength than a linear sorption band of the spectral sensitizing compound which undergoes two-photon absorption; and a linear absorption molar absorptivity of 10 or less.

(10) The two-photon recording method as defined in any one of Clauses 7 to 9, wherein the compound interacting with the spectral sensitizing dye comprises an organic borate compound.

(11) The two-photon recording method as defined in any one of Clauses 1 to 10, wherein the recording involving the use of two-photon absorption is effected in a non-rewritable process. That is, the record by the two-photon recording method can be non-rewritable.

(12) The two-photon recording method as defined in any one of Clauses 1 to 11, wherein the two-photon absorption recording material comprises a plurality of recording layers.

(13) A two-photon absorption recording material allowing a two-photon recording method defined in any one of Clauses 1 to 12.

(14) A two-photon absorption recording-reproduction (recording/reproduction) method, which comprises: subjecting a two-photon absorption recording material to two-photon absorption by which a modulation of a refractive index or absorptivity is recorded therein (hereinafter, sometimes referred to as “a refractive-index modulated recording” or “an absorptivity-modulated recording”), according to a two-photon recording method defined in any one of Clauses 1 to 13; irradiating the recording material with light; and then detecting the difference in reflectance or transmittance thus developed to effect reproduction.

(15) A two-photon absorption recording-reproduction (recording/reproduction) method, which comprises: subjecting a two-photon absorption recording material to two-photon absorption by which a modulation of a luminescence intensity is recorded therein (hereinafter, sometimes referred to as “a luminescence intensity-modulated recording”), according to a two-photon recording method defined in any one of Clauses 1 to 13; irradiating the recording material with light; and then detecting the difference in luminescence intensity thus developed to effect reproduction.

(16) A two-photon absorption three-dimensional optical recording medium comprising a two-photon absorption recording material defined in Clause 13.

(17) A two-photon absorption optical recording medium comprising a two-photon absorption recording material defined in Clause 13 stored in a light-screening cartridge during storage.

(18) A two-photon absorption three-dimensional optical recording/reproduction method comprising a two-photon recording/reproduction method defined in Clause 14 or 15.

(19) A three-dimensional volume display comprising a two-photon absorption recording material defined in Clause 13.

(20) A method for the production of a three-dimensional volume display comprising a two-photon recording method defined in any one of Clauses 1 to 12.

### DETAILED DESCRIPTION OF THE EXEMPLARY EMBODIMENTS

Although the invention will be described below with reference to the exemplary embodiments thereof the following exemplary embodiments and modifications do not restrict the invention.

According to an exemplary embodiment, a two-photon absorption compound has a great two-photon absorption section area (sensitivity). The use of the two-photon absorption recording material of the invention comprising the two-photon absorption compound makes it possible to effect two-photon absorption at a high sensitivity whereby refractive index-, absorptivity- or luminescence intensity-modulated recording can be made. A two-photon absorption recording material excellent particularly in storage stability can be provided.

Further, the use of the two-photon absorption optical recording material of the invention makes it possible to effect two-photon absorption three-dimensional optical recording/reproduction.

A two-photon recording method and two-photon absorption recording material according to an exemplary embodiment of the invention will be further described hereinafter.

A two-photon recording method of the invention includes: a first step of forming a latent image in a two-photo absorption recording material by two-photon absorption; a second step of subjecting the two-photon absorption recording material having the latent image to heat treatment so as to record a modulation of a refractive index, absorptivity or luminescence intensity in the two-photon absorption recording material in accordance with the latent image; and a third step of irradiating the two-photon absorption recording material entirely with light to fix the modulation. The recording can be reproduced without being erased (that is, the record can be reproduced based on the modulation without erasing the modulation.).

A two-photon recording method of the invention will be further described hereinafter. Through the following description, a two-photon absorption recording material of the invention, too, will be further described.

<Two-Photon Recording Methods>

As already described, a two-photon recording method of the invention includes a fast step of forming a latent image, a second step of modulating refractive index, absorptivity or luminescence intensity according to the latent image and a third stop of effecting irradiation with light to fix recording. If necessary, other steps may be provided. Firstly, the first to third steps will be further described.

(First Step)

At the first step, a latent image produced by two-photon absorption is formed in the two-photon absorption recording material described later. In other words, the first stop is a two-photon absorption step (hereinafter occasionally referred to as “two-photon absorption step”). In the case where as the two-photon absorption recording material there is used a photopolymerizable composition or a material containing such a photopolymerizable composition as described later, when the two-photon absorption recording material is irradiated with light, the irradiated area undergoes polymerization reaction and curing of the polymerizable compound in the photopolymerizable composition to cause two-photon absorption by which a latent image is formed.

As the light source to be used at the two-photon absorption step there is preferably used laser. The light source to be used in the invention is preferably any of ultraviolet ray, visible light and infrared ray having a wavelength of from 200 to 2,000 nm, more preferably ultraviolet ray, visible light or infrared ray having a wavelength of from 300 to 1,000 nm, even more preferably visible light or infrared having a wavelength of from 400 to 800 nm.

The laser employable herein is not specifically limited. In some detail, solid lasers or fiber lasers such as Ti-sapphire having an emission wavelength in the vicinity of central wavelength which is 1,000 nm, semiconductor lasers, solid lasers or fiber lasers used in CD-R having an emission wavelength in the vicinity of 780 nm, semiconductor lasers or solid lasers such as AlGaInP used in DVD-R having an emission wavelength of from 620 nm to 680 nm or semiconductor lasers such as GAN and InGaN having an emission wavelength in the vicinity of from 400 nm to 415 nm are preferably used.

Besides these lasers, solid or semiconductor SHG lasers such as YAG-SHG laser having an emission wavelength in the visible light range are preferably used.

The laser to be used in the invention may be a pulse-oscillated laser or CW laser.

In order to effect recording on the two-photon absorption recording material of the invention, it is preferred that the two-photon absorption recording material be irradiated with laser light having a longer wavelength than the linear absorption band of the two-photon absorption compound and a linear (one-photon) absorption molar absorptivity of 10 or less to induce two-photon absorption by which recording is effected. The linear absorption molar absorptivity of laser light is more preferably 1 or less, even more preferably 0.1 or less, most preferably zero.

The light to be used for reproduction is preferably the aforementioned laser light, for example. A laser light having the same or diffract power or pulse form but having the same wavelength as that for recording is more preferably used for reproduction.

Other examples of the light to be used for reproduction include carbon arc, high pressure mercury vapor lamp, xenon lamp, metal halide lamp, fluorescent lamp, tungsten lamps LED, and organic EL. In order to emit light beam having a specific wavelength range, a sharp cut filter, band pass filter, diffraction grating, etc. are preferably used.

(Second Step)

At the aforementioned second step, the two-photon absorption material which has a latent image formed therein at the first step is subjected to heat treatment so that a refractive index-, absorptivity- or luminescence intensity-modulated recording according to the latent image is made. In other words, the second step is recording forming step, In the case where the two-photon absorption recording material contains a color-developable or color-extinguishable material, the second step is a step at which the color-developable or color-extinguishable material undergoes imagewise color development or color extinction reaction according to the latent image by the two-photon absorption to make refractive index-, absorptivity- or luminescence intensity-modulated recording.

In the case where as the two-photon absorption recording material there is used, e.g., a material containing a photopolymerizable composition as well as a color-developable or color-extinguishable components when heated, the color-developable or color-extinguishable component reacts with a compound which reacts with the color-developable or color-extinguishable component to cause the color-developable or color-extinguishable component to color or decolor, or a specific group in the compound which causes color development or color extinction whereby color development or color extinction occurs according to the shape of the latent image formed at the first step to make refractive index-, absorptivity- or luminescence intensity-modulated recording. The aforementioned heat treatment is preferably effected in such a manner that the two-photon absorption recording material can be entirely treated.

The heating method to be effected during the aforementioned heat treatment can be properly selected from known methods. For example, a heat roller or the like can be used to effect heat treatment. The aforementioned heating temperature is normally preferably from 80° C. to 200° C., more preferably from 85° C. to 130° C. When the heating temperature falls below 80° C., the colored or decolored density can be insufficient. When the heating temperature exceeds 200° C., the two-photon absorption recording material can be colored or the support can be damaged. The heating time is preferably from 1 second to 5 minutes, more preferably from 3 seconds to 1 minute. Further, the heat treatment can be preceded by a step of uniformly preheating the entire surface of the two-photon absorption recording material at a predetermined temperature less than the color development or color extinction temperature to further enhance the sensitivity of the two-photon absorption recording material.

The term “color development reaction” as used herein is meant to indicate a reaction involving the change of absorption spectrum form or preferably either or both of the shift of λmax to longer wavelength and rise of molar absorptivity (ε) in absorption spectrum in the range of ultraviolet ray, visible light and infrared ray having a wavelength of from 200 nm to 2,000 nm. The color development reaction preferably occurs at a wavelength of from 200 nm to 1,000 nm, more preferably from 300 nm to 900 nm.

On the other hand, the term “color extinction reaction” as used herein is meant to indicate generically a reaction by which a color-extinguishable dye having absorption in the range of ultraviolet ray, visible light and infrared ray having a wavelength of from 200 to 2,000 nm undergoes either or both of the shift of λmax to longer wavelength and the reduction of molar absorptivity. The color extinction reaction preferably occurs at a wavelength of from 200 nm to 1,000 nm, more preferably from 300 nm to 900 nm.

The refractive index of the dye rises in the range of from close to linear absorption maxima wavelength (λmax) to wavelength longer than linear absorption maxima wavelength (λmax), rises drastically in the range of from λmax to wavelength about 200 nm longer than λmax. In this wavelength range, some dyer show a refractive index of more than 1.8, as high as more than 2 in some cases. On the other hand, organic compounds which are not a dye, such as binder polymer, normally have a refractive index of from about 1.4 to 1.6.

It is thus made obvious that the color development or color extinction by two-photon absorption makes it possible to fairly make not only a difference in absorbance but also a great difference in refractive index.

(Third Step)

At the aforementioned third step, the two-photon absorption recording material which has been subjected to heat treatment at the second step is entirely irradiated with light so that the refractive index-, absorptivity- or luminescence intensity-modulated recording in the two-photon absorption recording material is fixed while fixing the color of the spectral sensitizing dye. In other words, the third stop is a fixing stop of stabilizing the refractive index-, absorptivity- or luminescence intensity-modulated recording thus formed.

The entire irradiation of the two-photon absorption recording material with light can be accomplished by a method which comprises irradiating the entire surface of the recording layer with light at a time or a method which comprises gradually irradiating the recording surface with light by scanning until the entire surface of the recording layer is eventually irradiated with light. However, any method can be employed so far as the entire surface of the recording layer of the two-photon absorption recording material having a refractive index, absorptivity or luminescence intensity-modulated recording formed therein can be irradiated with substantially uniform light. Thus, the entire irradiation at the present step means that the entire surface of the recording material is uniformly irradiated with light to cause linear absorption (one-photon absorption) rather than two-photon absorption. This entire irradiation is called imagewise exposure or solid exposure.

The light source employable at the present step can be properly selected from the group consisting of known light sources having a wavelength of from ultraviolet to infrared range when the recording material comprises a light-absorbing material such as spectral sensitizing dye having absorption in a specific range incorporated therein. In some detail, a light source having a maximum absorption wavelength of from 300 nm to 1,000 nm is preferred. In particular, a laser source emitting blue, green or red beam, LED, flash lamp, fluorescent lamp, xenon lamp, mercury vapor lamp or the like is more desirable. In this case, a light source having a wavelength coincident with the absorption wavelength of the light-absorbing material such as spectral sensitizing dye used is preferably selected properly.

Referring to the irradiation time, it suffices if the two-photon absorption recording material is irradiated with light for a period of time long enough to fix the refractive index-, absorptivity- or luminescence intensity-recording thus formed and sufficiently extinguish the color derived from the spectral sensitizing dye. However, the irradiation time is preferably from several seconds to scores of minutes, more preferably from several seconds to several minutes.

When the two-photon absorption recording material is passed through the present step, the spectral sensitizing dye-derived coloring component left in the two-photon absorption recording material can be removed, making it possible to enhance the resolution of the two-photon absorption recording material. Further, the stability, storage properties nondestructive reproducibility, etch of the refractive index-, absorptivity- or luminescence intensity-modulated recording, i.e., two-photon recording can be enhanced.

Moreover, when as the color-developable component there is used a diazonium salt compound, the diazonium salt compound left in the recording layer having recording formed there, in by refractive index, absorptivity or luminescence intensity modulation can be also deactivated by irradiation with light to inhibit the color development reaction, making it possible to prevent density change, fading or the like and stabilize the storage stability of the two-photon absorption recording material.

The spectral sensitizing dye is preferably decomposed to lose its absorption and sensitizing capacity at the second or third step.

In the case where as the two-photon absorption recording material there is used a material having a multi-layered photosensitive thermosensitive layer having a plurality of monochromatic recording layers having different color-developable or color-extinguishable compounds laminated on each other, it is preferred that the respective recording layer be exposed to light having a wavelength coincident with the wavelength to which it is sensitive using a plurality of laser sources at the aforementioned first step. At the present step, too, taking into account the light sensitivity of the various recording layers, it is preferred that these recording layers be independently or simultaneously irradiated with light from all the plurality of light sources to fix the refractive index-, absorptivity- or luminescence intensity-modulated recording and extinguish the color thereof. In this case, it is preferred that absorptivity or luminescence intensity be modulated and applied to a full-color three-dimensional volume display.

On the other hand, in the case where as the two-photon absorption recording material there is used a material having a multi-layered photosensitive thermosensitive recording layer having a plurality of recording layers having the same color-developable or color-extinguishable compound laminated on each other, it is preferably applied to a two-photon absorption three-dimensional optical recording material which undergoes refractive index modulation to effect recording and reflectance modulation to effect reproduction.

The two-photon recording/reproduction method of the invention preferably comprises subjecting a two-photon absorption recording material having a two-photon absorption compound to two-photon absorption by which refractive index- or absorptivity-modulated recording is made thereon, irradiating the recording material with light, and then detecting the difference in reflectance or transmittance thus developed to effect reproduction.

On the other hand, a method is preferably used which comprises subjecting the two-photon absorption recording material having a two-photon absorption compound to two-photon absorption by which luminescence-modulated recording is made thereon, irradiating the recording material with light and then detecting the difference in luminescence intensity to effect reproduction.

The emission thus made may be fluorescent or phosphorescent but is preferably fluorescent from the standpoint of emission efficiency.

It is preferred that the two-photon recording method of the invention involve no wet process.

The two-photon absorption recording method of the invention is preferably not of rewritable type. The term “not of rewritable type” as used herein is meant to indicate the type which causes irreversible reaction to perform recording. Once recorded, data can be stored without being rewritten even in an attempt to overwrite thereon. Thus, the two-photon recording method of the invention is suitable for the storage of important data which are needed to be stored over an extended period of time. It goes without saying that data can be additionally recorded on unrecorded area. In this sense, this type of a recording method is called “write-once-read-many type” recording method.

In the two-photon absorption recording material of the invention, the size of the color-developed or color-extinguished portion produced by recording is preferably from 10 nm to 100 μm, more preferably from 50 nm to 5 μm, even more preferably from 50 nm to 2 μm.

In order to enable the reproduction of data from the recording material, the size of the reacted or color developed area is preferably from 1/20 to 20 times, more preferably from 1/10 to 10 times, most preferably from ⅕ to 5 times the wavelength of radiation with which the recording material is irradiated.

The chemical reaction, color development reaction or like reactions which occur when the two-photon absorption recording of the invention undergoes two-photon absorption preferably involve no thermal decomposition from the standpoint of enhancement of sensitivity in particular. In other words, these reactions preferably occur in a photon mode.

In some detail, recording is preferably effected in a mechanism different from that of the methods practically used in existing CD-R or DVD-R taking into account the writing/transferring speed in the recording material in particular.

The two-photon recording/reproduction method of the invention is preferably used for optical recording/reproduction systems such as DVD-R and DVD-BL (BD), near-field optical recording/reproduction methods, three-dimensional optical recording/reproduction methods, three-dimensional volume display recording/reproduction methods, etc., more preferably for three-dimensional optical recording/reproduction methods. In other words, the two-photon recording/reproduction method is preferably used for two-photon absorption three-dimensional optical recording/reproduction method or two-photon absorption three-dimensional volume display recording/reproduction method.

Similarly, the two-photon absorption recording material of the invention is preferably used for optical recording media such as DVD-R and DVD-BL (BD), near-field optical recording media, three-dimensional optical recording media, three-dimensional volume display recording materials, etc., more preferably for three-dimensional optical recording materials and media. In other words, the two-photon recording material of the invention is preferably used for two-photon absorption three-dimensional optical recording material or two-photon absorption three-dimensional volume display recording material.

In the case where the two-photon absorption recording material of the invention is used as an optical recording medium, the two-photon absorption recording material is preferably stored in a light-screening cartridge during storage. It is also preferred that the two-photon absorption recording material be provided with a light filter capable of cutting part of wavelength range of ultraviolet ray, visible light and infrared ray other than recording light and reproduced light on the surface or back surface or on the both surfaces thereof.

In the case where the two-photon absorption recording material of the invention is used as an optical recording medium, the optical recording medium may be in the form of disc, card or tape or in any other form.

The two-photon absorption compound and two-photon absorption recording material of the invention may undergo simultaneous absorption of a multiplicity of photons, i.e., three or more photons.

The two-photon absorption recording material of the invention will be further described hereinafter.

<Two-Photon Absorption Recording Material>

The two-photon absorption recording material to be used in the two-photon recording method of the invention can be properly selected from the group consisting of materials which can be subjected to two-photon absorption to form a latent image and can be heated to record a refractive index-, absorptivity or luminescence intensity-modulation according to the latent image. In particular, a photopolymerizable composition comprising at least an active ray-photopolymerizable compound having at least one ethylenically unsaturated bond and a photopolymerization initiator or a photosensitive thermosensitive two-photon absorption recording material having such a photopolymerizable composition is preferred. The aforementioned photopolymerizable composition and photosensitive thermosensitive two-photon absorption recording material will be further described hereinafter.

(Photopolymerizable Composition)

The aforementioned photopolymerizable composition comprises at least a compound having at least one ethylenically unsaturated bond which can be polymerized with light (hereinafter occasionally referred to as “photopolymerizable compound”) and a photopolymerization initiator and optionally other components. When the laser-focused area is subjected to two-photon absorption at the first step so that the photopolymerization initiator generates radicals by which the photopolymerizable compound undergoes polymerization reaction in the composition, only the irradiated area cures to form a latent image, In the case where the aforementioned photopolymerizable composition contains a color-developable or color-extinguishable component, the color-developable or color-extinguishable component undergoes color development or extinction according to the latent imago at the second step. Thus, refractive index-, absorptivity- or luminescence intensity-modulated recording is formed in the two-photon absorption recording material. Further, when the two-photon absorption recording material is then entirely irradiated with light at the third step, the color of the photopolymerization initiator component left in the two-photon absorption recording material is extinguished, making it possible to enhance the storage properties of the refractive index-, absorptivity- or luminescence intensity-modulated recording. Further, the extinction of color makes it possible to enhance the diffraction efficiency.

—Photopolymerizable Compound—

The aforementioned photopolymerizable compound is a compound having at least one ethylenically unsaturated bond per molecule which undergoes polymerization reaction to cure when irradiated with light. Examples of the aforementioned photopolymerizable compound include the following photopolymerizable monomers (D1, D2). These photopolymerizable monomers D1 and D2 are preferably used in combination with the compound C free of polymerizable group as described later.

The aforementioned photopolymerizable monomer D1 is preferably a photopolymerizable monomer having at least one vinyl group per molecule. Specific examples of such a photopolymerizable monomer include acrylic acids and salts thereof, acrylic acid esters, acrylamides, methacrylic acids and salts thereof, methacrylic acid esters, methacrylamides, maleic anhydride, maleic acid esters, itaconic acid, itaconic acid esters, styrenes, vinylethers, vinylesters, N-vinyl heterocyclic groups, arylethers, and allylesters.

Preferred among these photopolymerizable monomers are those having a plurality of vinyl groups per molecule. Preferred examples of the photopolymerizable monomers include acrylic acid esters and methacrylic acid esters of polyvalent alcohols such as trimethylolpropane and pentacrythritol, acrylic acid esters and methacrylic acid esters of polyvalent phenols or bisphenols such as resorcinol, pyrogallol and phloroglucinol, acrylate- or methacrylate-terminated epoxy resins, and acrylate- or methacrylate-terminated polyesters.

Particularly preferred among these photopolymerizable monomers are ethylene glycol diacrylate, ethylene glycol dimethacrylate, trimethylol propane triacrylate, pentaerythritol, tetraacrylate, dipentaerythritol hydroxy pentaacrylate, hexanediol-1,6-dimethacrylate, and diethylene glycol dimethacrylate. The aforementioned photopolymerizable monomer D1 preferably has a molecular weight of from about 100 to 5,000, more preferably from about 300 to 2,000.

Preferred examples of the aforementioned photopolymerizable monomer D2 include styrenesulfonyl aminosalicylic acid, vinylbenzyloxyphthalic acid, zinc β-methacryloxyethoxysalicylate, zinc β-acryloxyethoxysalicylate, vinyloxyethyloxybenzoic acid, β-methacryloxyethyl orselinate, β-acryloxyethyl orselinate, β-methacryloxy ethoxy phenol, β-acryloxyethoxy phenol, β-methacryloxy ethyl-β-resorcinate, β-acryloxyethyl-β-resorcinate, hydroxystyrenesulfonic acid-N-ethylamide, β-methacryloxypropyl-p-hydroxybenzoate, β-acryloxy propyl-p-hydroxybenzoate, methacryloxymethylphenol, acryloxymethylphenol, methacrylamidepropanesulfonic acid, acrylamidepropanesulfonic acid, β-methacryloxy ethoxy-dihydroxybenzene, β-acryloxyethoxy-dihydroxybenzene, γ-styrenesulfonyloxy-β-methacryloxy propanecarboxylic acid, γ-acryloxypropyl-α-hydroxyethyloxysalicylic acid, β-hydroxyethoxyphenol, β-methacryloxyethyl-p-hydroxy cinnamate, β-acryloxyethyl-p-hydroxy cinnamate, 3,5-distyrenesulfonic acid amidephenol, methacryloxyethoxy phthalic acid, acryloxyethoxyphthalic acid, methacrylic acid, acrylic acid, methacryloxyethoxyhydroxynaphtoic acid, acryloxyethoxyhydroxynaphtoic acid,3-β-hydroxy ethoxyphenol, β-methacryloxyethyl-p-hydroxybenzoate, and β-acryloxyethyl-p-hydroxybenzoate,β′-methacryloxyethyl-β-resorcinate, β-methacryloxy ethyloxycarbonylhydroxybenzoic acid, β-acryloxy ethyloxycarbonylhydroxybenzoic acid, N,N′-di-β-methacryloxyethylaminosalicylic acid, N,N′-di-β-acryloxyethylaminosalicylic acid, N,N′-di-β-methacryloxyethylaminosulfonylsalicylic acid, and N,N′-di-β-acryloxyethylaminosulfonylsalicylic acid.

—Photopolymerization Initiator—

When exposed to light, the aforementioned photopolymerization initiator can generate radicals to cause and accelerate a polymerization reaction in the recording layer. This polymerization reaction causes the recording layer to cure, making it possible to form a latent image by desired two-photon absorption.

The aforementioned photopolymerization initiator can be properly selected from the group consisting of known photopolymerization initiators. In particular, a photopolymerization initiator containing a spectral sensitizing dye having a maximum absorption wavelength of from 300 nm to 1,000 nm and a compound having mutual interaction with the spectral sensitizing dye is preferred. However, in the case where the compound having mutual interaction with the spectral sensitizing dye is a compound having both a dye moiety having a maximum absorption wavelength of from 300 nm to 1,000 nm and a borate moiety, it may act also as the aforementioned spectral sensitizing dye.

Examples of the known photopolymerization initiator include those disclosed in U.S. Pat. No. 4,950,581 (lines 35, column 20-line 35, column 21). Other examples of the known photopolymerization initiator include triazine compounds such as triazine and trihalomethyltriazine (e.g., 2,4-bis(trichloromethyl)-6-(4-stylphenyl)-s-triazine) disclosed in EP-A-137452, DE-A-2718254, DE-A-2243621, U.S. Pat. No. 4,950,581 (line 60, column 14-line 44, column 18). In the case where the aforementioned photopolymerization initiator is used in a hybrid system, a cationic photopolymerization initiator may be exemplified in addition to free radical curing agent. Preferred examples of the aforementioned cationic photopolymerization initiator include benzoyl peroxide, peroxide compounds such as peroxide disclosed in U.S. Pat. No. 4,950,581 (lines 17-25, column 19), aromatic sulfonium or iodonium salts disclosed in U.S. Pat. No. 4,950,581 (line 60, column 18-line 104 column 19), and cyclopentadienyl-arene iron (II) complex salts such as (η6-isopropylbenzene)-(η5-cyclopentadienyl)-iron (II) hexafluorophosphate.

Preferred examples of the aforementioned dye/boron compound include those disclosed in JP-A-62-143044, JP-A-1-138204, JP-T-6-505287, and JP-A-4-261406.

In the two-photon absorption recording material of the invention, the spectral sensitizing dye having a maximum absorption wavelength of from 300 nm to 800 nm is preferably a two-photon absorption compound.

The two-photon absorption compound of the invention is a compound which undergoes nonresonant two-photon absorption (phenomenon of simultaneous absorption of two photons leading to excitation in an energy region in which the (linear) absorption of the compound is not present).

In order to apply the invention to two-photon absorption recording materials, particularly to tow photon absorption three-dimensional optical recording materials, a two-photon absorption compound which can undergo two-photon absorption at a high sensitivity to produce excited state efficiently is needed to attain a high transferring (recording) speed.

The efficiency at which the two-photon absorption compound undergoes two-photon absorption is represented by two-photon absorption section area δ and is defined by 1 GM=1×10⁻⁵⁰ cm⁴s/photon. The two-photon absorption section area δ of the two-photon absorption compound in the two-photon absorption recording material of the invention is preferably 100 GM or more, more preferably 1,000 GM or more, even more preferably 5,000 GM or more, most preferably 10,000 GM or more from the standpoint of enhancement of writing speed and reduction of size and cost of laser.

The spectral sensitizing dye which is the two-photon absorption compound of the invention is preferably a compound which undergoes two-photon absorption of any of ultraviolet rays, visible light and infrared rays having a wavelength of from 200 nm to 2,000 nm, more preferably visible light or infrared rays having a wavelength of from 400 nm to 1,100 nm, even more preferably visible light or infrared rays having a wavelength of from 400 nm to 800 nm to produce excited state.

The spectral sensitizing dye which is the two-photon absorption compound of the invention is preferably a compound having linear absorption in any range of ultraviolet rays, visible light and infrared rays having a wavelength of from 300 nm to 800 nm, that is, preferably is a dye, more preferably having linear absorption in any of ultraviolet rays and visible light having a wavelength of from 300 nm to 700 nm.

The spectral sensitizing dye which is the two-photon absorption compound of the invention may be any such compound. Examples of the spectral sensitizing dye employable herein include those disclosed in patents related to “Bunko zokan shikiso to sougo sayo suru kaboubutsu (Compounds having mutual interaction with spectral sensitizing dye)”, cited later, “Research Disclosure”, vol. 200, December 1980, Item 2003, 6, and Katsumi Tokumaru and Shin Ogawara, “Zokanzai (Sensitizer)”, Kodansha, pp. 160-163, 1987.

Specific examples of these spectral sensitizing dyes include 3-ketocoumarine compounds disclosed in JP-A-58-15603, thiopyrilium salts disclosed in JP-A-58-40302, naphthothiazole melocyanine compounds disclosed in JP-B-59-28328 and JP-B-60-53300, and melocyanine compounds disclosed in JP-B-61-9621, JP-B-62-3842, JP-A-59-89303, and JP-A-60-60104.

Further, dyes disclosed in “Kinosei Shikiso no Kagaku (Chemistry of Functional Dyes)”, CMC, pp. 393-416, 1981, and “Shikizai (Coloring Materials)”, 60[4]212-224 (1987)) may be used. Specific examples of these dyes include cationic methine dyes, cationic carbonium dyes, cationic quinoneimine dyes, cationic indoline dyes, and cationic styryl dyes.

Examples of the aforementioned spectral sensitizing dyes (i.e., two-photon absorption compounds) include keto dyes such as coumarine (ketocoumarine or sulfonocoumarine) dye, melostyryl dyes, oxonol dye and hemioxonol dye, non-keto dyes such as non-ketopolymethine dye, triarylmethane dye, xanthene dye, anthracene dye, rhodamine dye, acridine dye, aniline dye and azo dye, non-ketopolymethine dyes such as azomethine dye, cyanine dye, carbocyanine dye, dicarbocyanine dye, tricarbocyanine dye, hemicyanine dye and styryl dye, and quinoneimine dyes such as azine dye, oxazine dye, thiazine dye, quinoline dye and thiazole dye.

The proper use of the aforementioned spectral sensitizing dye makes it possible to predetermine the spectral sensitivity of the photopolymerization initiator used in the two-photon absorption recording material to a range of from ultraviolet to infrared. The aforementioned various spectral sensitizing dyes can be used singly or in combination of two or more thereof.

The amount of the aforementioned spectral sensitizing compound to be used is preferably from 0.1% to 10% by mass, more preferably from 0.5% to 5% by mass based on the photopolymerizable monomer in the photopolymerizable composition (mass).

As the compound having mutual interaction with the aforementioned spectral sensitizing dye there may be used one or more compounds selected from the group consisting of known compounds which can begin to undergo photopolymerization reaction with the aforementioned photopolymerizable monomer (D1, D2). The presence of this compound with the aforementioned spectral sensitizing dye allows the spectral sensitizing dye to be drastically sensitive to light in the spectral absorption wavelength range and generate radicals efficiently, making it possible to enhance the sensitivity and inhibit the generation of radicals using arbitrary light source having a wavelength of from ultraviolet to infrared. Examples of the compound having mutual interaction with the aforementioned spectral sensitizing dye include organic borate compounds and the following compounds.

Aromatic ketones such as benzophenone, 4,4-bis(dimethylamino)benzophenone, 4-methoxy-4′-dimethyl aminobenzophenone, 4,4′-dimethoxybenzophenone, 4-dimethylaminobenzophenone, 4-dimethylamino acetophenone, benzylanthraquinone, 2-tert-butyl anthraquinone, 2-methylathraquinone, xanthone, thioxthone, 2-chlorothioxanthone, 2,4-diethyl thioxanthone, fluorenone, acridone and bisacylphosphine oxide (e.g., bis(2,4,6-trimethylbenzoyl)-phenyl phosphine oxide produced by Ciba Specialty Chemicals Co., Ltd.); benzoin and benzoinethers such as benzoin methyl ether, benzoin ethyl ether, benzoin isopropyl ether and benzoin phenyl ether; 2,4,6-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-diphenylimidazole diner, 2-(o-methoxyphenyl)-4,5-diphenylimidazole dimer and 2-(o-methoxyophenyl)-4,5-diphenylimidazole dimer; polyhalogen compounds such as carbon tetrabromide, phenyl tribromomethylsulfone and phenyltrichloro methyl ketone; compounds disclosed in JP-A-59-133428, JP-B-57-1819, JP-B-57-6096 and U.S. Pat. No. 3,615,455; S-triazine derivatives having trihalogen-substituted methyl group disclosed in JP-A-58-29803 such as 2,4,6-tris(trichloromethyl)-S-triazine, 2-methoxy-4,6-bis(trichloromethyl)-S-triazine, 2-amino-4,6-bis (trichloromethyl)-S-triazine and 2-(P-methoxystyryl)-4,6-bis(trichloromethyl)-S-triazine; organic peroxides disclosed in JP-A-59-189340 such as methyl ethyl ketone peroxide, cyclohexanone peroxide, 3,3,5-trimethylcyclohexanone peroxide, benzoyl peroxide, ditertiary butyl diperoxide isophthalate, 2,5-dimethyl-2,5-di(benzolyperoxy)hexane, tertiary butyl peroxy benzoate, a,a′-bis(tertiary-butyl peroxy isopropyl)benzene, dicumyl peroxide and 3,3′,4,4′-tetra-(tertiary butylperoxycarbonyl)benzophenone; adinium salt compounds disclosed in U.S. Pat. No. 4,743,530; organic boron compounds disclosed in EP 0223587 such as tetramethyl ammonium salt of triphenyl butyl borate, tetrabutyl ammonium salt of triphenyl butyl borate and tetramethyl ammonium salt of tri(P-methoxyphenyl) butyl borate; and other diaryl iodonium salts and iron arene complexes.

Combinations of two or more compounds having mutual interaction with spectral sensitizing dye have been known. These compounds may be used in the invention. Examples of the combinations of two or more compounds having mutual interaction with spectral sensitizing dye include combination of 2,4,5-triarylimidazole dimer and mercaptobenzoxazole, combination of 4,4′-bis(dimethyl amino)benzophenone and benzoin methyl ether disclosed in U.S. Pat. No. 3,427,161, combination of benzoyl-N-methylnaphthothiazoline and 2,4-bis(trichloromethyl)-6-(4′-methoxyphenyl)-triazole disclosed in U.S. Pat. No. 4,239,850, combination of dialkylaminobenzoic acid ester and dimethylthioxanthone disclosed in JP-A-57-23602, and combination of three compounds, i.e., 4,4′-bis(dimethylamino)benzophenone, benzophenone and polyhalogenated methyl disclosed in JP-A-59-78339.

Among them, the combination of 4,4′-bis(dimethylamino)benzphenone and benzophenone, the combination of 2,4-diethylthioxanthone and ethyl 4-dimethylaminobenzoate or the combination of 4,4′-bis(dimethylamino)benzophenone and 2,4,5-triarylimidazole dimmer is preferred.

Preferred among the aforementioned “compounds having mutual interaction with spectral sensitizing dye” are organic borate compounds, benzoin ethers, S-triazine derivative having trihalogen-substituted methyl group, organic peroxides and adinium salt compounds. More desirable among those compounds are organic borate compounds. The use of the “compound having mutual interaction with spectral sensitizing dye” in combination with the aforementioned spectral sensitizing dye makes it possible to generate radicals locally and effectively on the two-photon absorption area and attain higher sensitivity.

Examples of the aforementioned organic borate compound include organic borate compounds (hereinafter occasionally referred to as “borate compound I”) disclosed in JP-A-62-143044, JP-A-9-188685, JP-A-9-188686 and JP-A-9-188710, and spectral sensitizing dye-based borate compounds obtained from cationic dye (hereinafter occasionally referred to as “borate compound II”). Specific examples of the aforementioned borate compound I will be given below, but the invention is not limited thereto.

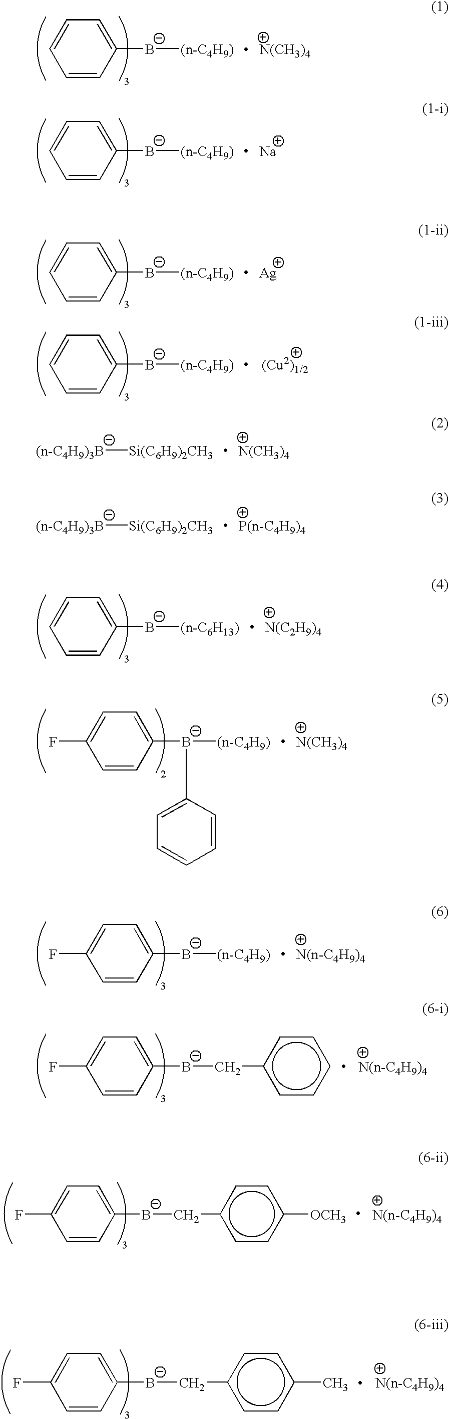

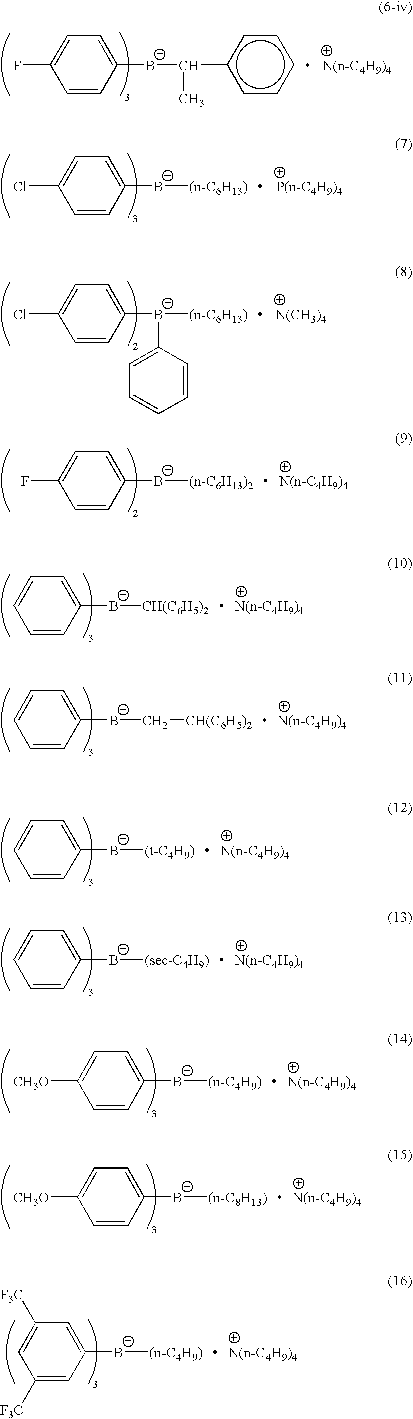

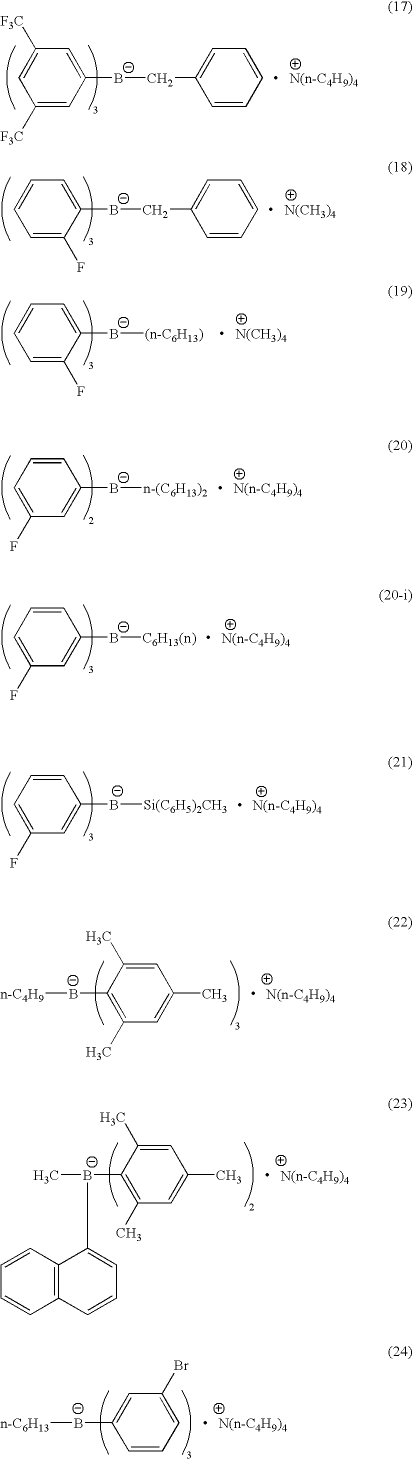

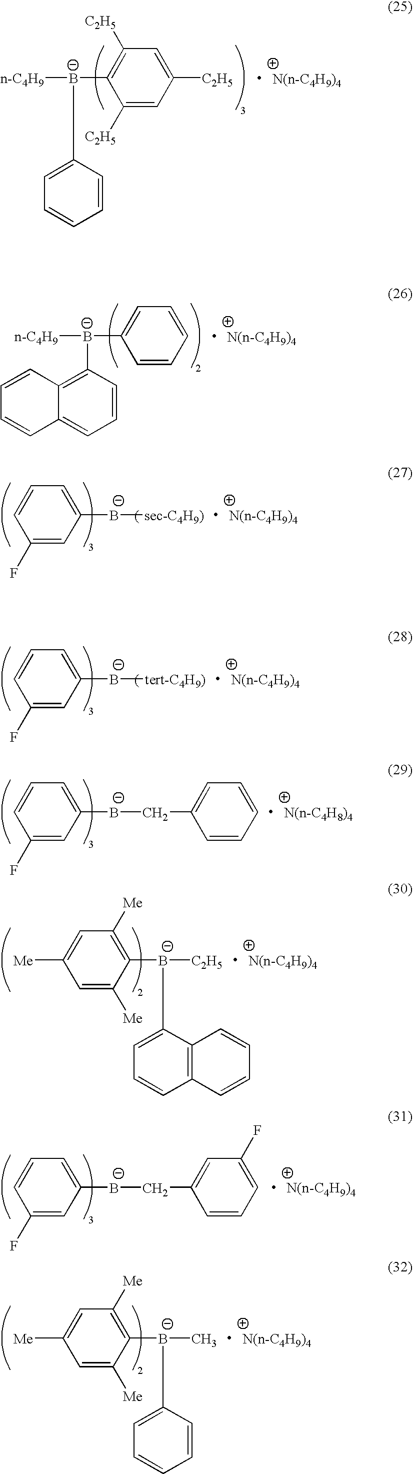

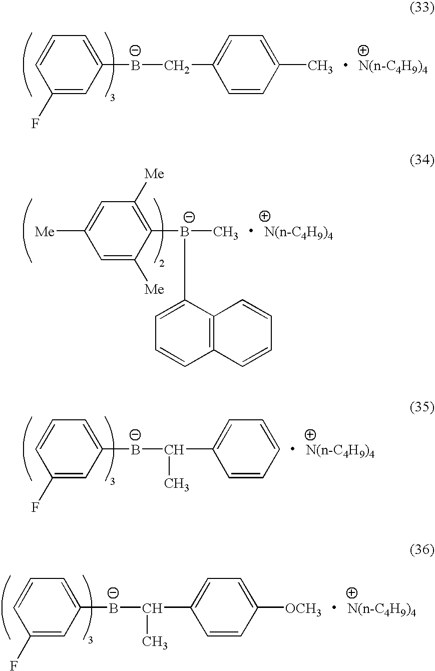

Further examples of the aforementioned borate compound I include spectral sensitizing dye-based organic borate compounds (borate compound II) which can be obtained from cationic dyes disclosed in the above cited “Kinosei Shikiso no Kagaku (Chemist of Functional Dyes)”, CMC, pp. 393-416, 1981, and “Shikizai (Coloring Materials)”, 60[4]212-224 (1987)). This borate compound II is a compound having a dye moiety and a borate moiety in combination. This borate compound II has three functions, that is, effectively generating the excited state by two-photon absorption due to the two-photon absorbing capacity of the dye moiety, acceleration of polymerization reaction by the radical-releasing capacity of the borate moiety and extinction of the color of the spectral sensitizing (two-photon absorption compound) dye present therewith.

In some detail, any cationic dye having a maximum wavelength range of 300 nm or more, preferably from 300 nm to 1,100 nm, more preferably from 300 nm to 800 nm can be used to advantage. Preferred among these cationic dyes are cationic methine dyes, polymethine dyes, triarylmethane dyes, indoline dyes, azine dyes, xanthene dyes, thioxanthone dyes, cyanine dyes, hemicyanine dyes, rhodamine dyes, azamethine dyes, oxazine dyes, phenothiazine dyes, acridine dyes, pyrylium dyes, and styryl dyes. More desirable among these cationic dyes are cationic cyanine dyes, hemicyanine dyes, rhodamine dyes and azamethine dyes.

Further examples of these cationic dyes include squarylium cyanine dyes, melocyanine dyes, oxonol dyes, styryl dyes, benzylidene dyes, cinnamylidene dyes, coumarine dyes, ketocoumarine dyes, styrylcoumarine dyes, pyrane dyes and styryl dyes which are neutral or anionic themselves but become a cationic dye when they have a cationic group. Preferred among these dyes are melocyanine dyes, oxonol dyes, benzylidene dyes and styryl dyes having cationic group.

The borate compound II obtained from the aforementioned organic cationic dye can be obtained from an organic cationic dye and an organic boron anion according to the method disclosed in European Patent Application Disclosure No; 223,587(A1).

Specific examples of the borate compound II (two-photon absorption compound) obtained from cationic dye will be given below, but the invention is limited thereto.

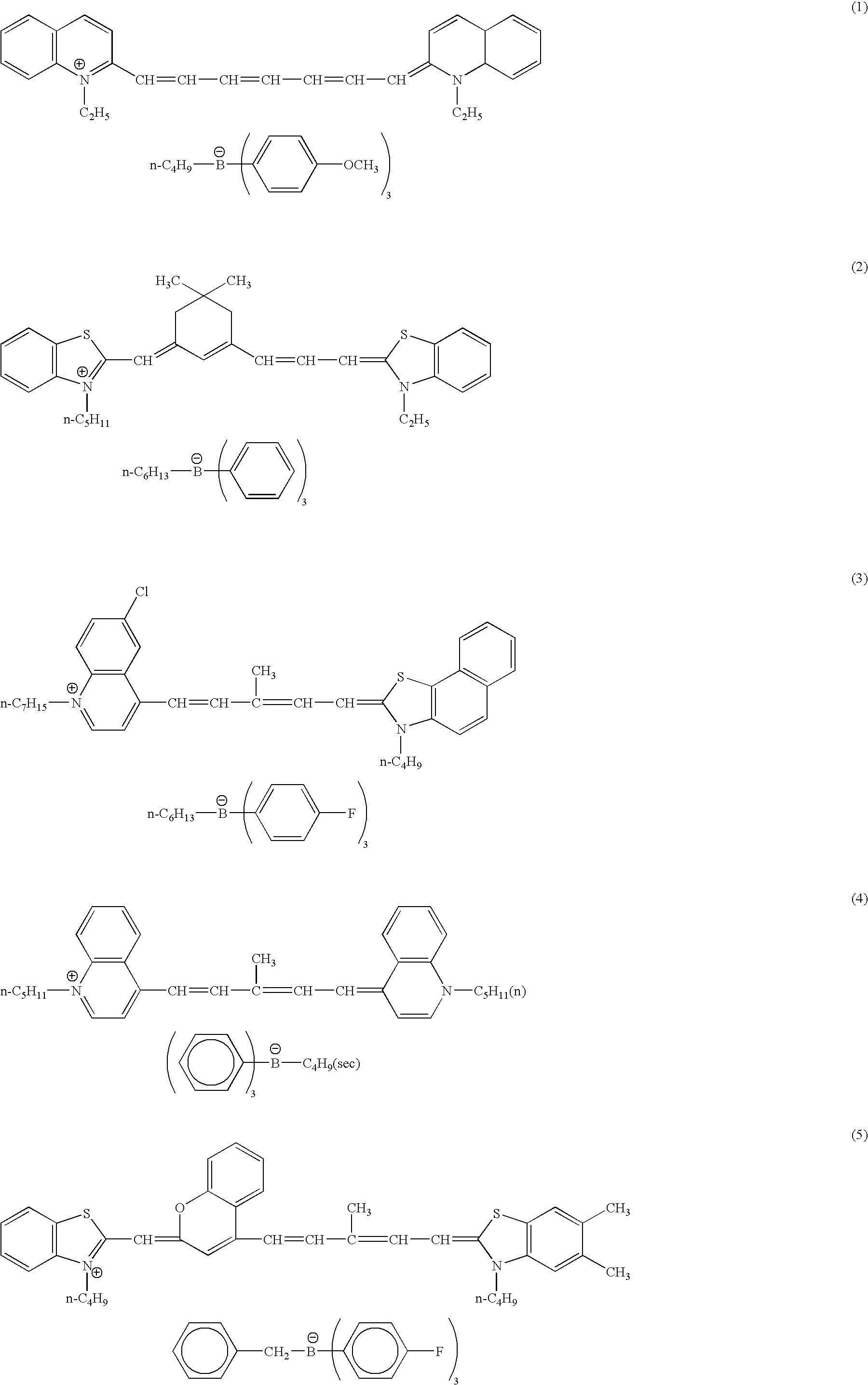

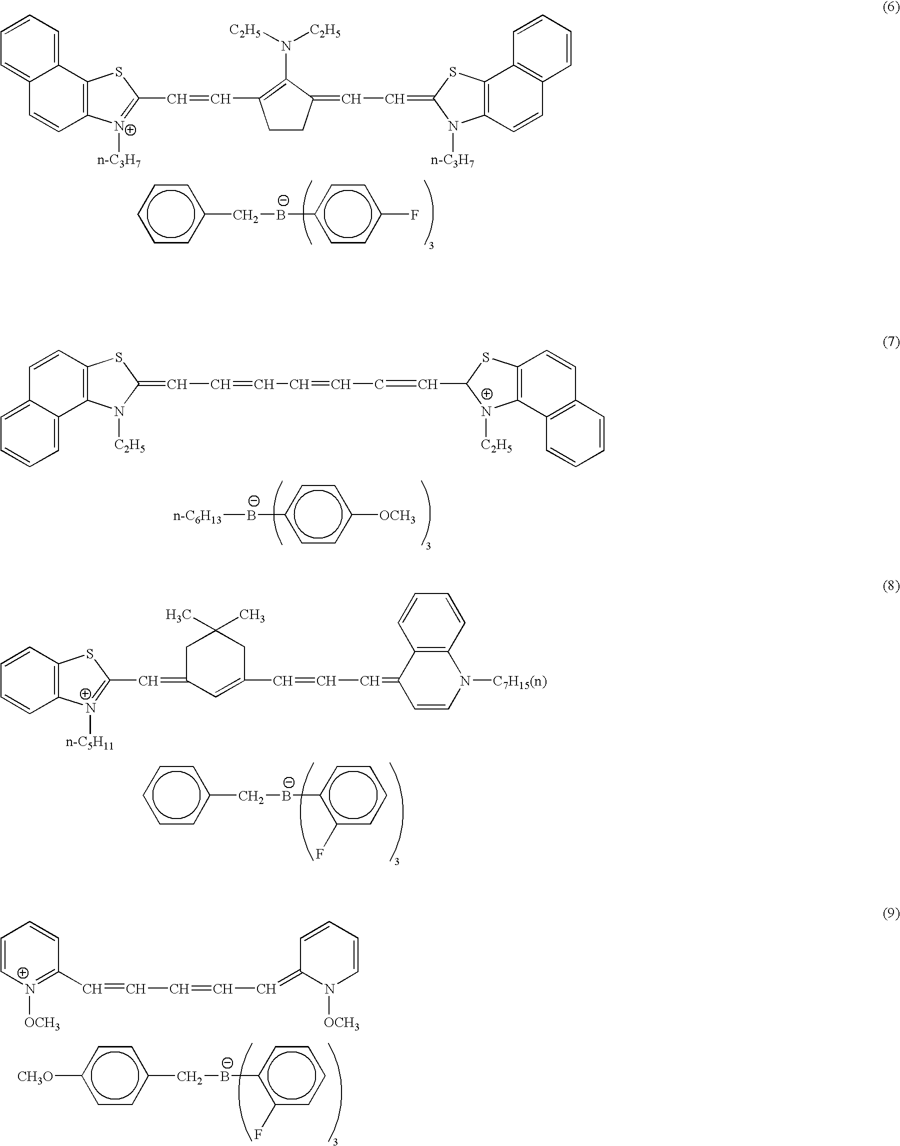

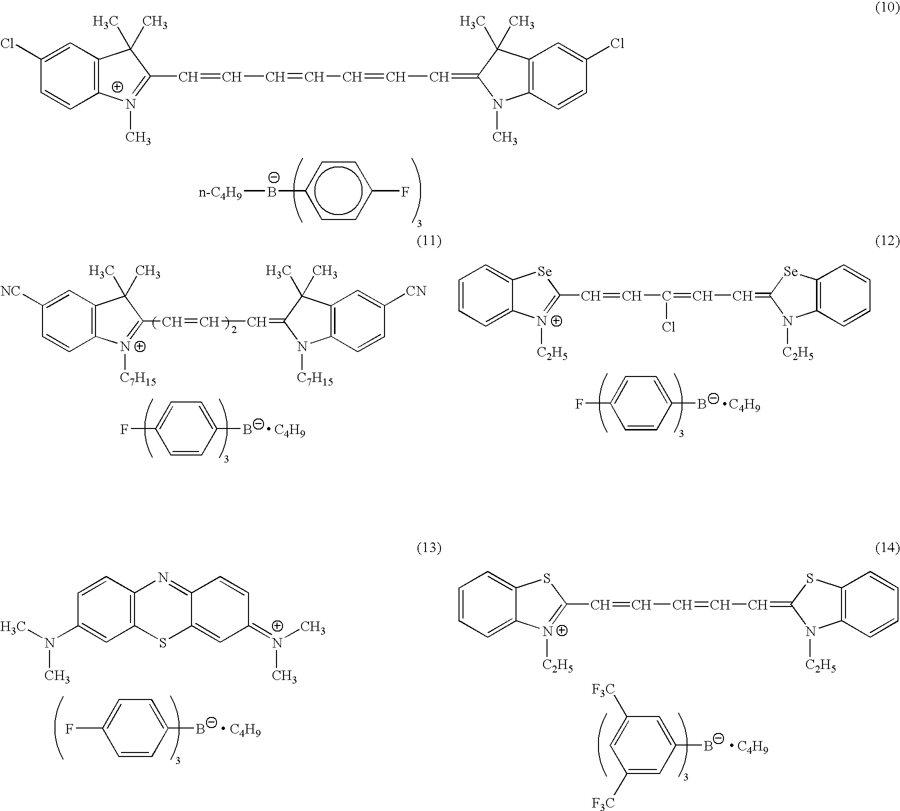

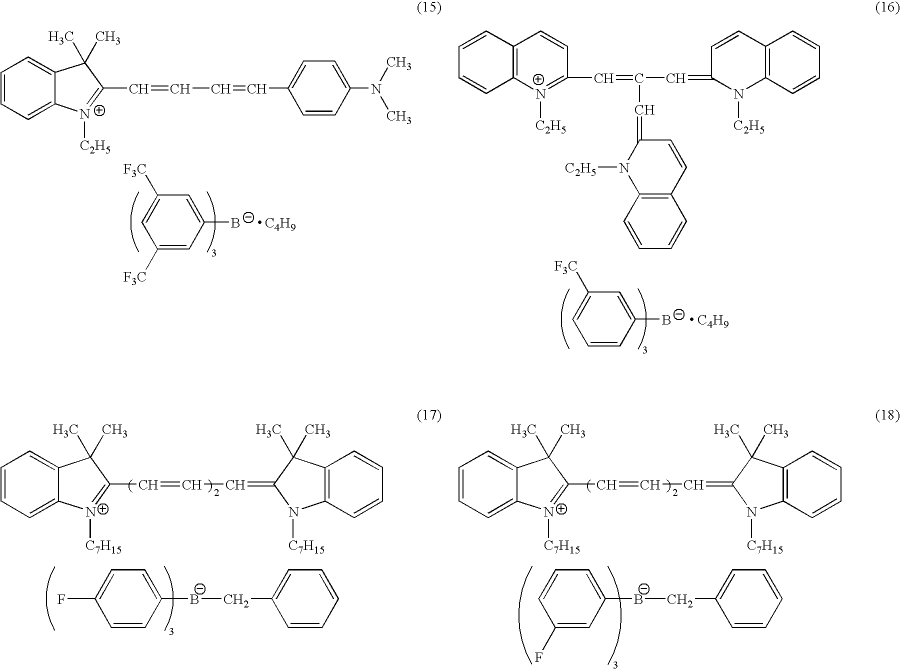

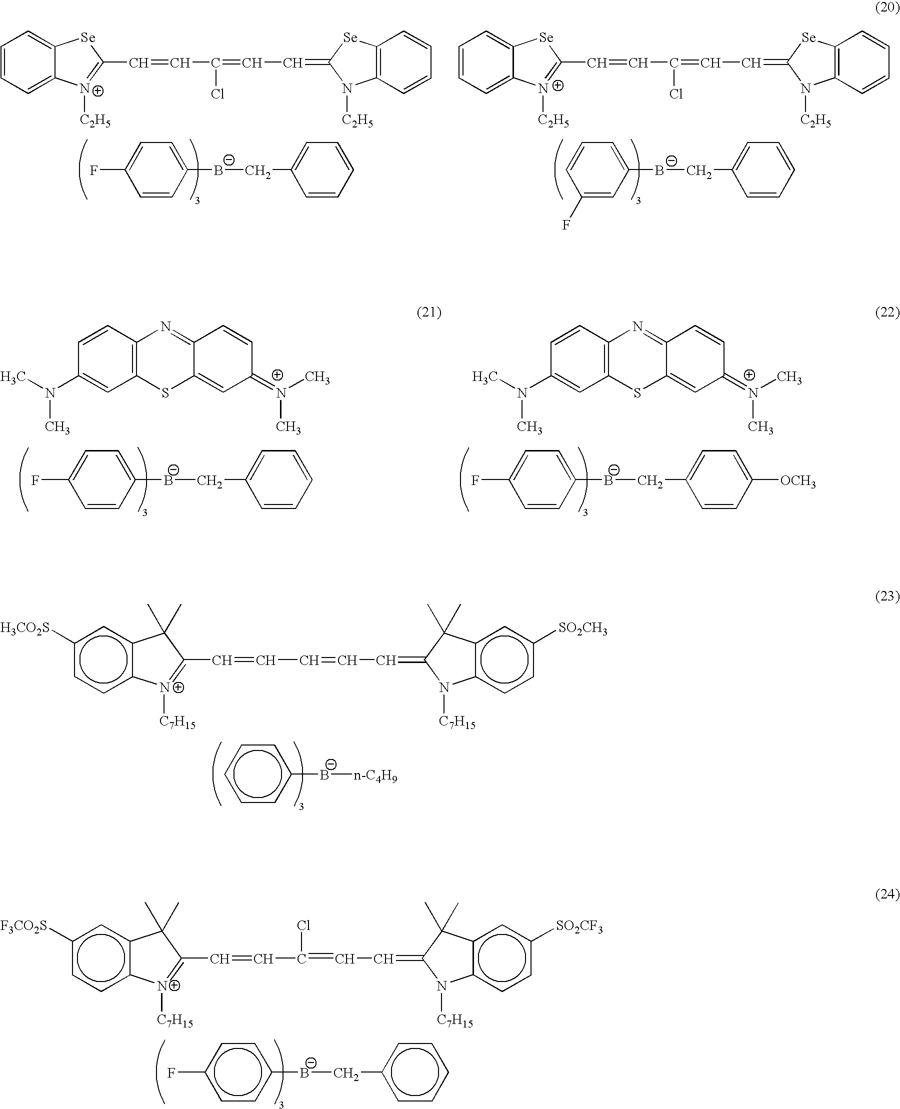

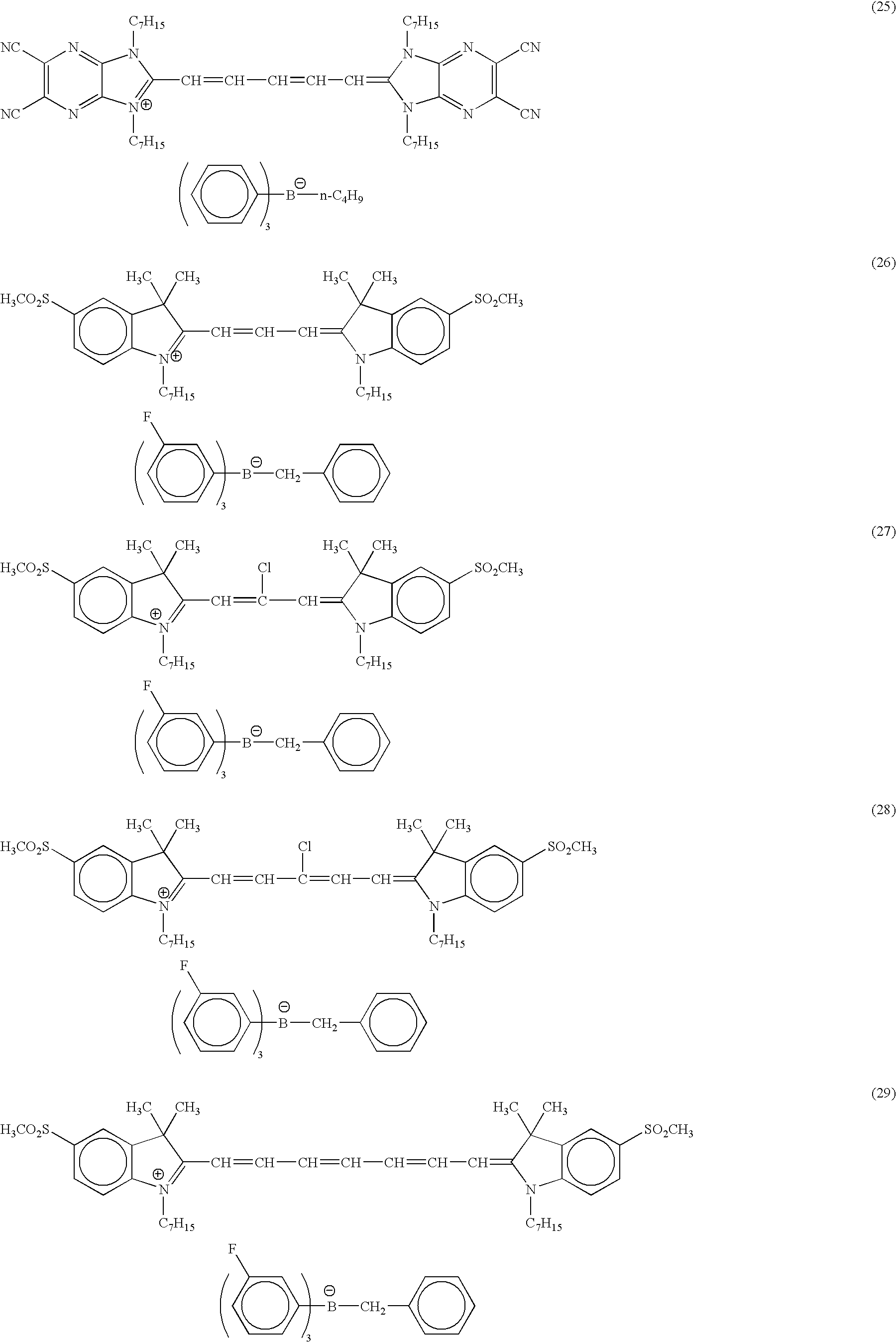

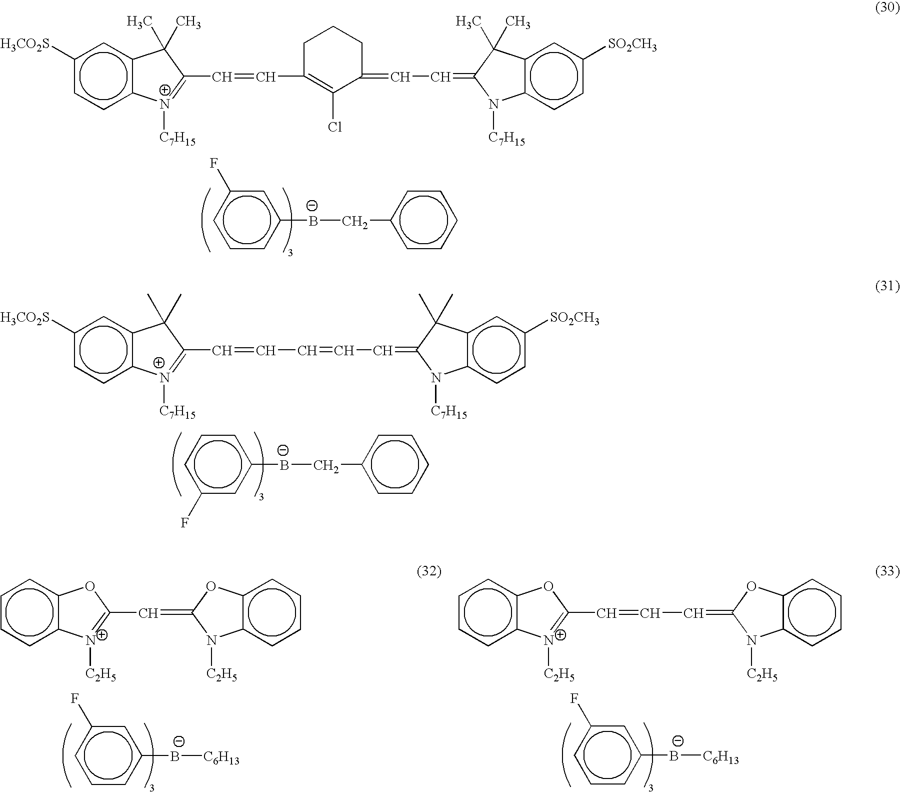

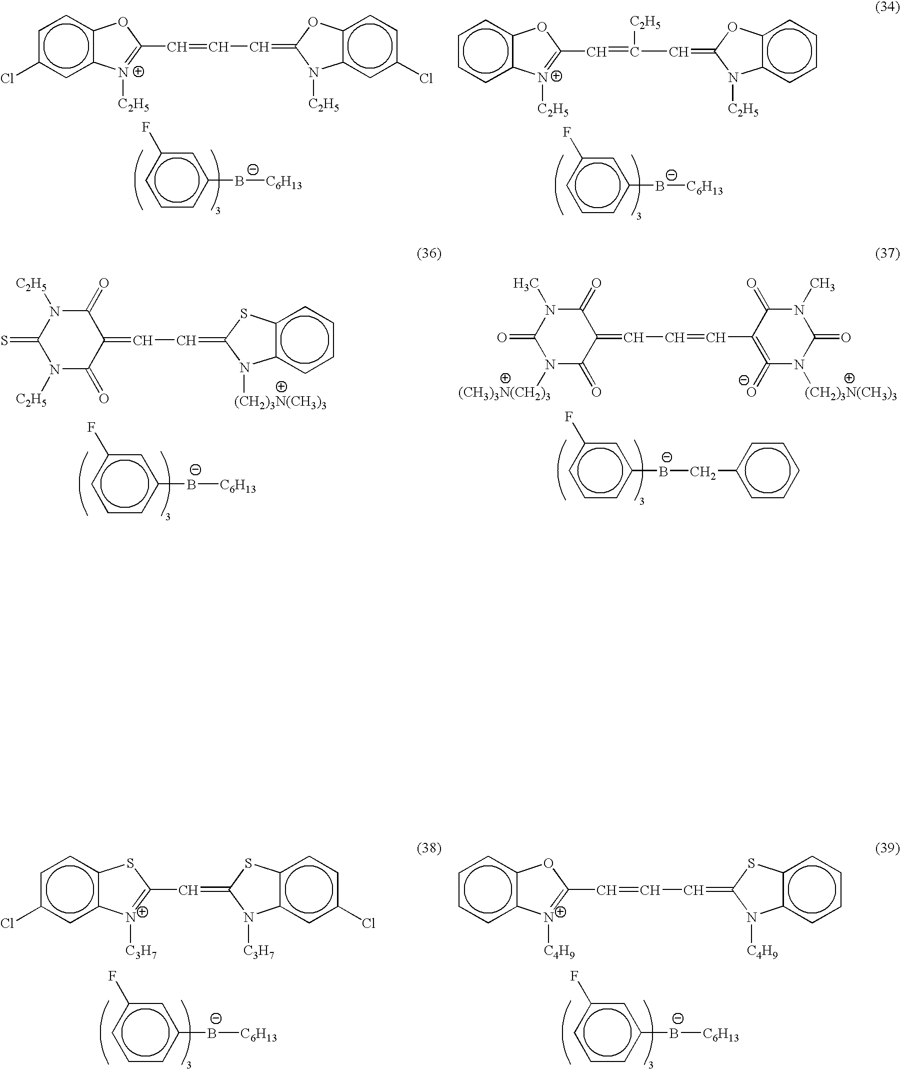

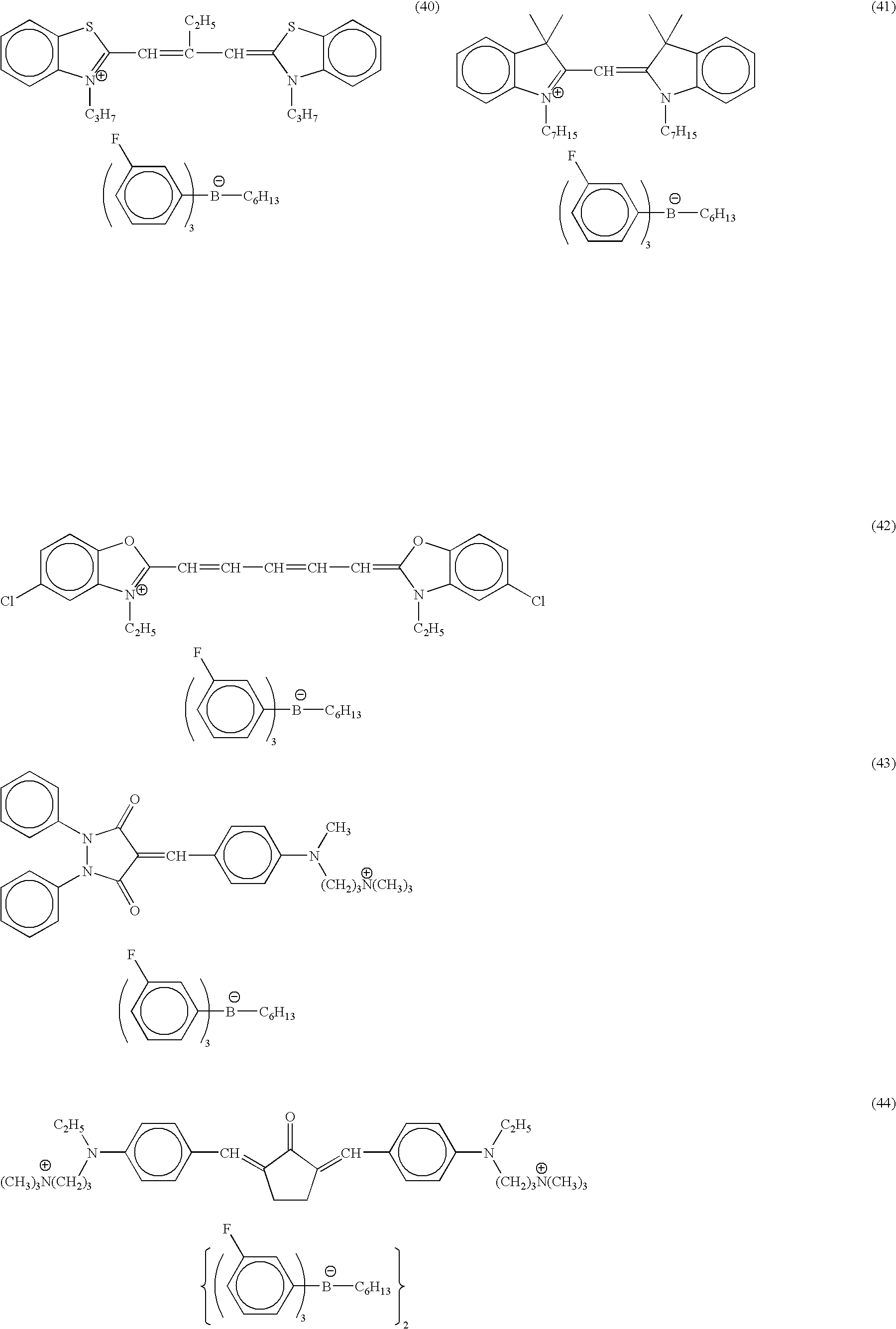

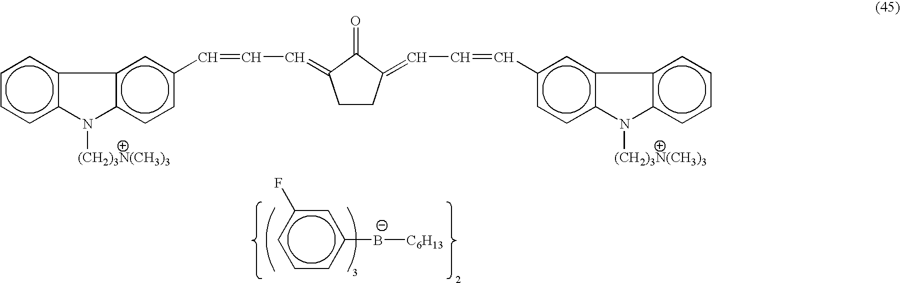

The aforementioned borate compound II is a multi-functional compound as mentioned above. The aforementioned photopolymerization initiator is preferably formed by a spectral sensitizing dye and a compound having mutual interaction with the spectral sensitizing dye in proper combination from the standpoint of provision of high sensitivity and sufficient color-extinguishability. In this case, the photopolymerization initiator is more preferably a photopolymerization initiator (1) having the aforementioned spectral sensitizing dye and borate compound I in combination or a photopolymerization initiator (2) having the aforementioned borate compound I and borate compound II in combination.

In this case, the mixing ratio of the spectral sensitizing dye and the organic borate compound in the photopolymerization initiator is very important for the enhancement of high sensitivity and the provision of sufficient color-extinguishability by irradiation at the fixing step. In the case of the aforementioned photopolymerization initiator (1), it is particularly preferred from the standpoint of provision of sufficiently high sensitivity and color-extinguishability that the photopolymerization initiator comprise the borate compound I incorporated therein in an amount required to sufficiently extinguish the color of the special sensitizing dye left in the layer in addition to the spectral sensitizing dye/borate compound I required for photopolymerization reaction in a molar ratio of 1/1. In other words, the mixing molar ratio of spectral sensitizing dye/borate compound I is preferably from 1/1 to 1/50, more preferably from 1/1.2 to 1/30, most preferably from 1/1.2 to 1/20. When the mixing molar ratio falls below 1/1, sufficient polymerization reactivity and color-extinguishability cannot be obtained. When the mixing molar ratio exceeds 1/50, the resulting coating solution exhibits deteriorated spreadability to disadvantage.

In the case of the aforementioned polymerization initiator (2), it is particularly preferred from the standpoint of provision of sufficiently high sensitivity and color-extinguishability that the borate compound I and the borate compound II be used in combination such that the amount of the borate site is not smaller than equimolecular to the dye site. The mixing ratio of borate compound I/borate compound II is preferably from 1/1 to 50/1, more preferably 1.2/1 to 30/1, most preferably from 1.2/1 to 20/1. When the mixing ratio of borate compound I/borate compound II falls below 1/1, radicals are little generated, making it impossible to obtain sufficient polymerization reactivity and color-extinguishability. When the mixing ratio of borate compound I/borate compound II exceeds 50/1, sufficient sensitivity cannot be obtained to disadvantage.

The sum of the amount of the spectral sensitizing dye and the organic borate compound in the photopolymerization initiator is preferably from 0.1 to 10% by mass, more preferably from 0.1 to 5% by mass, most preferably from 0.1 to 1% by mass based on the amount of the compound having a polymerizable group. When the sum of the amount of the spectral sensitizing dye and the organic borate compound falls below 0.1% by mass, the effect of the invention cannot be obtained. When the sum of the amount of the spectral sensitizing dye and the organic borate compound exceeds 10% by mass, the resulting coating solution exhibits deteriorated storage properties as well as deteriorated spreadability.

For other preferred examples of the two-photon absorption compound and examples of synthesis of the two-photon absorption compound, reference can be made to JP-A-2004-123668, JP-A-2004-224864, JP-A-2003-183213, JP-A-2005-25152, JP-A-2004-279795, JP-A-2004-279794, JP-A-2004-250545, JP-A-2004-279646, JP-A-2004-339435, JP-A-2004-341425, JP-A-2004-126440, JP-A-2004-149517, and JP-A-2005-71570.

—Other Components—

The aforementioned photopolymerizable composition may comprise the following components incorporated therein as necessary. In other words, as auxiliaries there may be added an oxygen scavenger or a reducing agent such as active hydrogen donor chain transfer agent for the purpose of accelerating polymerization reaction or other compounds for accelerating polymerization in chain transferring manner. Examples of the aforementioned oxygen scavenger include phosphine, phosphonate, phosphite, primary silver salt, and other compounds which can be easily oxidized by oxygen. Specific examples of these oxygen scavengers include N-phenyl glycine, trimethylbarbituric acid, N,N-dimethyl-2,6-diisopropylaniline, and N,N,N-2,4,6-pentamethyl anilic acid. Examples of useful polymerization accelerators include thiols, thioketones, trihalomethyl compounds, lophine dimer compounds, iodonium salts, sulfonium salts, adinium salts, organic peroxides, and azides.

(Photosensitive Thermosensitive Two-Photon Absorption Recording Material)

The aforementioned photosensitive thermosensitive two-photon absorption recording material is not specifically limited in its structure so far as it comprises the already described photopolymerizable composition incorporated therein. For example, the aforementioned photosensitive thermosensitive two-photon absorption recording material may have a properly selected structure such as two-photon absorption recording material having a recording layer containing a photopolymerizable composition provided on a support depending on the purpose, In particular, as the basic stricture there is preferably used a photosensitive thermosensitive two-photon absorption recording material arranged as described in the following clauses (a) or (b).

(a) A photosensitive thermosensitive two-photon absorption recording material having on a support a photosensitive thermosensitive recording layer containing a photopolymerizable composition comprising a color-developable or color-extinguishable component A contained in a thermo-responsive microcapsule and at least a substantially colorless compound B and a photopolymerization initiator provided on the exterior of the thermo-responsive microcapsule, which compound B has a polymerizable group having at least one ethylenically unsaturated bond and a site which reacts with the color-developable or color-extinguishable component A to cause color development or color extinction in the same molecule; and

(b) A photosensitive thermosensitive two-photon absorption recording material having on a support a photosensitive thermosensitive recording layer containing a photopolymerizable composition comprising a thermo-responsive microcapsule containing a color-developable or colors-extinguishable component A and at least n substantially colorless compound C, a substantially colorless compound D and a photopolymerization initiator provided on the exterior of the thermo-responsive microcapsule, which compound C reacts with the color-developable or color-extinguishable component A to cause color development or color extinction, which compound D has a polymerizable group having at least one ethylenically unsaturated bond and a site which reacts with the color-developable or color-extinguishable component A to cause color development or color extinction in the same molecule.

In the aforementioned photosensitive thermosensitive two-photon absorption recording material (a), the photopolymerizable composition provided on the exterior of the microcapsule at the laser-focused portion undergoes polymerization reaction with radicals generated from the photopolymerization initiator by two-photon absorption to cure. Thus, a desired latent image is formed. Subsequently, when the photosensitive thermosensitive two-photon absorption recording material is heated, the aforementioned compound B present on the unfocused portion then moves through interior of the two-photon absorption recording material where it reacts with the color-developable or color-extinguishable component A in the capsule to cause color development or color extinction. Accordingly, color development or color extinction doesn't occur in the laser-focused portion. The portion in the unfocused portion which has not been cured undergoes color development or color extinction. In this manner, this type of a photosensitive thermosensitive two-photon absorption recording material forms a refractive index-, absorptivity- or luminescence intensity-modulated recording.

Specific examples of this embodiment include a two-photon absorption recording material comprising a positive-working photosensitive thermosensitive two-photon absorption recording material having a photosensitive thermosensitive two-photon absorption recording layer comprising a compound containing an electron-accepting group and a polymerizable group in the same molecule and a photosetting composition containing a photopolymerization initiator provided on the exterior of a microcapsule and an electron-donating colorless dye contained in the microcapsule as disclosed in JP-A-3-87827. In this case, at the aforementioned first step, the two-photon absorption recording material is subjected to two-photon absorption so that the photosetting composition present on the exterior of the microcapsule is polymerized and cured to form a latent image. Subsequently, at the second step, the two-photon absorption recording material is heated to cause the compound containing an electron-accepting group and a polymerizable group in the same molecule present on the unfocused portion to move through the interior of the two-photon absorption recording material where it reacts with the electron-donating colorless dye in the microcapsule to cause color development or color extinction. Thus, recording is formed by refractive index, absorptivity or luminescence intensity modulation. Further, at the third step, the two-photon absorption recording material is irradiated with light from the light source used at the first step to fix the refractive index-, absorptivity- or luminescence intensity-modulated recording and extinguish the remaining photopolymerization initiator component. Accordingly, the area of latent image corresponding to the laser-focused portion where two-photon absorption has occurred undergoes neither color development nor color extinction. Only the area corresponding to the unfocused portion which, has not been cured undergoes color development or color extinction, making it possible to form a high contrast sharp refractive index-, absorptivity- or luminescence intensity-modulated interference band, i.e., two-photon recording.

In the aforementioned photosensitive two-photon absorption recording material (b), the compound D having a polymerizable group on the laser-focused portion undergoes polymerization of radicals generated from the photopolymerization initiator which has reacted upon two-photon absorption to cure, thereby forming a desired latent image. The aforementioned compound C moves depending on the properties of the latent image (cured area) to react with the color-developable or color-extinguishable component A in the capsule. Thus, a refractive index-, absorptivity- or luminescence intensity-modulated recording is formed. Accordingly, this type of a photosensitive thermosensitive two-photon absorption recording material undergoes color development or color extinction in the laser-focused portion where two-photon absorption has occurred to form a refractive index-, absorptivity- or luminescence intensity-modulated recording.

Specific examples of this embodiment of a two-photon absorption recording material include a two-photon absorption recording material comprising a negative-working photosensitive thermosensitive recording material having a photosensitive thermosensitive recording layer comprising an electron-accepting compound, a polymerizable vinyl monomer and a photopolymerization initiator provided on the exterior of an microcapsule and an electron-donating colorless dye contained in the microcapsule as disclosed in JP-A-4-211252.

The mechanism of formation of recording by refractive index, absorptivity or luminescence intensity modulation is not definitely known but can be presumed as follows, In some detail, when the two-photon absorption recording material is subjected to two-photon absorption at the first step, the vinyl monomer present on the exterior of the microcapsule undergoes polymerization while the electron-accepting compound present in the laser-focused portion is not caught by the polymer thus formed but shows a lowered mutual interaction with the vinyl monomer and thus is present in the form of a mobile compound having a high diffusion speed. On the other hand, the electron-accepting compound in the unfocused portion is present trapped by the vinyl monomer present therewith. Accordingly, when the two-photon absorption recording material is heated at the second step, the electron-accepting compound present in the laser-focused portion preferentially moves through the interior of the two-photon absorption recording material where it reacts with the electron-donating colorless dye in the microcapsule to cause color development or color extinction by which a refractive index-, absorptivity- or luminescence intensity-modulated recording is formed. The electron-accepting compound in the unfocused portion cannot permeate through the capsule wall even when heated. Accordingly, the electron-accepting compound doesn't react with the electron-donating colorless dye and thus doesn't make contribution to color development or color extinction. Subsequently, when the two-photon absorption recording material is entirely irradiated with light at the third step, the refractive index-, absorptivity or luminescence intensity-modulated recording formed by color development or color extinction is fixed while the color of the remaining photopolymerization initiator is extinguished. Accordingly, this type of a photosensitive thermosensitive two-photon absorption recording material allows the formation of a refractive index-, absorptivity- or luminescence intensity-modulated recording with color development or color extinction at the laser-focused portion when two-photon absorption has occurred but without color development or color extinction at the unfocused portion, making it possible to form a high contrast sharp two-photon recording.

Further, a photosensitive thermosensitive two-photon absorption recording material comprising a photosensitive thermosensitive recording layer formed by a plurality of recording layers provided on a support may be provided.

The various constituents of the photosensitive thermosensitive two-photon absorption recording material will be further described hereinafter. The photosensitive light-sensitive two-photon absorption recording material comprises as color-developable or color-extinguishable sources a color-developable or color-extinguishable component A contained in a microcapsule and a substantially colorless compound (aforementioned compound B or C; hereinafter occasionally referred to as “compound causing color development or extinction”) incorporated therein, which substantially colorless compound reacting with the color-developable or extinguishable component A to cause the color development or extinction thereof.

Description will begin with the case where the two-photon absorption recording material of the invention employs color development reaction.

Preferred examples of combination of the two components (color-developable component A and compound causing color development) as the coloring source include the following combinations (a) to (r) (in the following examples, the former indicates a color-developable component and the latter indicates a compound causing color development.)

(a) Combination of electron-donating dye precursor and electron-accepting compound;

(b) Combination of diazonium salt compound and coupling component (hereinafter occasionally referred to as “coupler compound”);

(c) Combination of organic acid metal salt such as silver behenate and silver stearate and reducing agent such as protocatechinic acid, spiraindane and hydroquinone;

(d) Combination of long-chain aliphatic acid iron salt such as ferric stearate and ferric myristate and phenol such as tactic acid, gallic acid and ammonium salicylate;

(e) Combination of salt of organic acid such as acetic acid, stearic acid and palmitic acid with heavy metal such as nickel, cobalt, lead, copped iron, mercury and silver and sulfide of alkaline metal or alkaline earth metal such as calcium sulfide, strontium and potassium sulfide or combination of the aforementioned organic acid heavy metal salt and organic chelating agent such as s-diphenyl carbazide and diphenyl carbazone;

(f) Combination of heavy metal sulfate such as sulfate of silver, lead, mercury and sodium and sulfur compound such as sodium tetrathionate, sodium thiosulfate and thiourca;

(g) Combination of aliphatic acid ferric salt such as ferric stearate and aromatic polyhydroxy compound such as 3,4-hydroxytetraphenylmethane;

(h) Combination of organic acid metal salt such as silver oxalate and mercury oxalate and organic polyhydroxy compound such as polyhydroxy alcohol, glycerin and glycol;

(i) Combination of aliphatic acid ferric salt such as ferric peralgonate and ferric laurate and thiocetyl carbamide or isothiocetyl carbamide derivative;

(j) Combination of organic acid lead salt and thiourea derivative such as ethylene thiourea and N-dodecyl thiourea;

(k) Combination of higher aliphatic acid heavy metal salt such as ferric stearate and copper stearate and zinc dialkyldithiocarbaminate;

(l) Oxazine dye-forming combination such as combination of resorcin and nitroso compound;

(m) Combination of formazane compound and reducing agent and/or metal salt;

(n) Combination of protected dye (or leuco dye) precursor and deprotecting agent;

(o) Combination of oxidation type coloring agent and oxidizing agent;

(p) Combination of phthalonitrile and diiminoisoindoline (combination causing the production of phthalocyanine);

(q) Combination of isocyanate and diiminoisoindoline (combination causing the production of colored pigment); and

(r) Combination of pigment precursor and acid or base (combination causing the formation of pigment)

Among the aforementioned color-developable components A, the color-developable component contained in a microcapsule is preferably a substantially colorless electron-donating dye precursor (hereinafter referred to as “electron-donating colorless dye”) or diazonium salt compound.

As the aforementioned electron-donating colorless dye there may be used one which has been heretofore known. Any compound which can react with the aforementioned compound B or C to undergo color development or extinction can be used. Specific examples of these electron-donating colorless dyes will be given below, but the electron-donating colorless dye employable herein is not limited thereto. Specific examples of these electron-donating colorless dyes include various compounds such as phthalide-based compounds, fluorane-based compounds, thiazine-based compounds, indolyl phthalide compounds, leucoauramine-based compounds, rhodamine lactam-based compounds, triphenylmethane-based compounds, triazene-based compounds, spiropyrane-based compounds, pyrazine-based compounds, fluorene-based compounds and cyanine-based compounds (leucocyanine compound).

Examples of the phthalide-based compounds employable herein include compounds disclosed in U.S. Reissued Pat. No. 23,024, U.S. Pat. Nos. 3,491,111, 3,491,112, 3,491,116 and 3,509,174. Specific examples of these compounds include 3,3-bis(p-dimethylaminophenyl)-6-dimethylaminophthalide, 3,3-bis(p-diethylamino-o-butoxyphenyl)-4-azaphthalide, 3-(p-diethylamino-butoxyphenyl)-3-(1-pentyl-2-methylindole-3-il)-4-azaphthalide, and 3-(p-dipropylamino-o-methylphenyl)-3-(1-octyl-2-methylindole-3-il)-5-aza(or -6-aza, or -7-aza)phthalide.

Examples of the fluorane-based compounds employable herein include compounds disclosed in U.S. Pat. Nos. 3,624,107, 3,627,787, 3,641,011, 3,462,828, 3,681,390, 3,920,510 and 3,959,571. Specific examples of these compounds include 2-(dibenzylamino)fluorane, 2-anilino-3-methyl-6-diethylaminofluorane, 2-anilino-3-methyl-6-dibutylaminofluorane, 2-anilino-3-methyl-6-N-ethyl-N-isoamylaminofluorane, 2-anilino-3-methyl-6 N-methyl-N-cyclobexylaminofluorane, 2-anilino-3-chloro-6-diethylaminofluorane, 2-anilino-3-methyl-6-N-ethyl-N-isobutylaminofluorane, 2-anilino-6-dibutylamino fluroane, 2-anilino-3-methyl-6-N-ethyl-N-tetrahydro furfurylaminofluorane, 2-anilino-3-methyl-6-piperidinoaminofluorane, 2-(o-chloroanilino)-6-diethylaminofluorane, and 2-(3,4-dichloroanilino)-6-diethylaminofluorane.

Examples of the thiazine-based compounds employable herein include benzoylleucomethylene blue, and p-nitrobenzylleucomethylene blue. Examples of the leucoauramine-based compounds employable herein include 4,4′-bis-dimethylaminobenzhydrin benzyl ether, N-halophenyl-leucoauramine, and N-2,4,5-trichlorophenyl leucoauramine.

Examples of the rhodaminelactam-based compounds employable herein include rhodamine-B-anilinolactam, and rhodamine-(p-nitrilo)lactam. Examples of the spiropyrane-based compounds include compounds disclosed in U.S. Pat. No. 3,971,808. Specific examples of these compounds include 3-methyl-spiro-dinaphthopyrane, 3-ethyl-spiro-dinaphthopyrane-3,3′-dichloro-spiro-dinaphthopyrane, 3-benzylspiro-dinaphthopyrane, 3-methyl-naphtho-(3-methoxy-benzo)spiropyrane, and 3-propyl-spiro-dibenzopyrane.

Examples of the pyridine-based compounds and pyrazine-based compounds include compounds disclosed in U.S. Pat. Nos. 3,775,424, 3,853,869 and 4,246,318. Examples of the fluorene-based compounds include compounds disclosed in JP-A-63-094878 (Japanese Patent Application No. 61-240989).

Specific preferred examples of the aforementioned electron-donating colorless dyes include the following compounds, but the invention is not limited thereto.

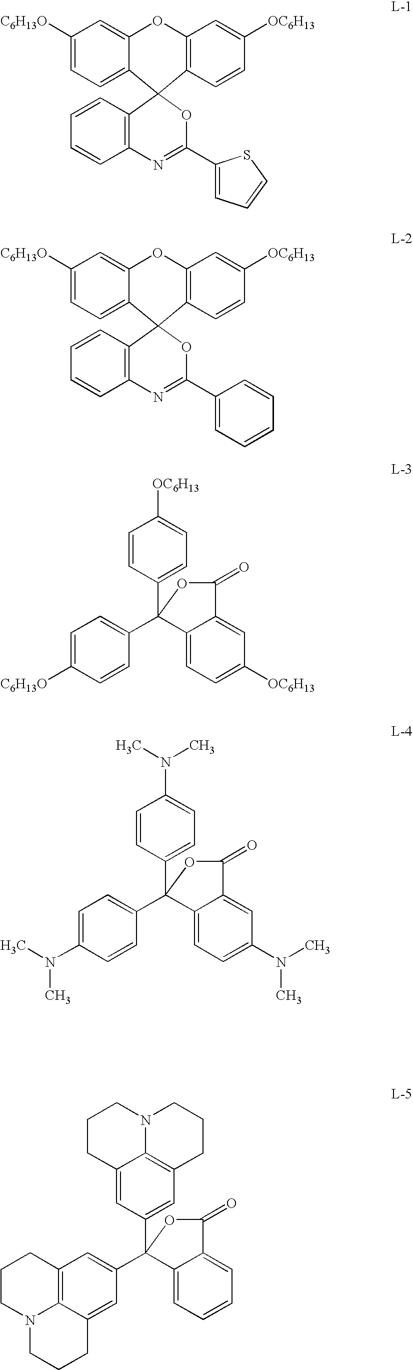

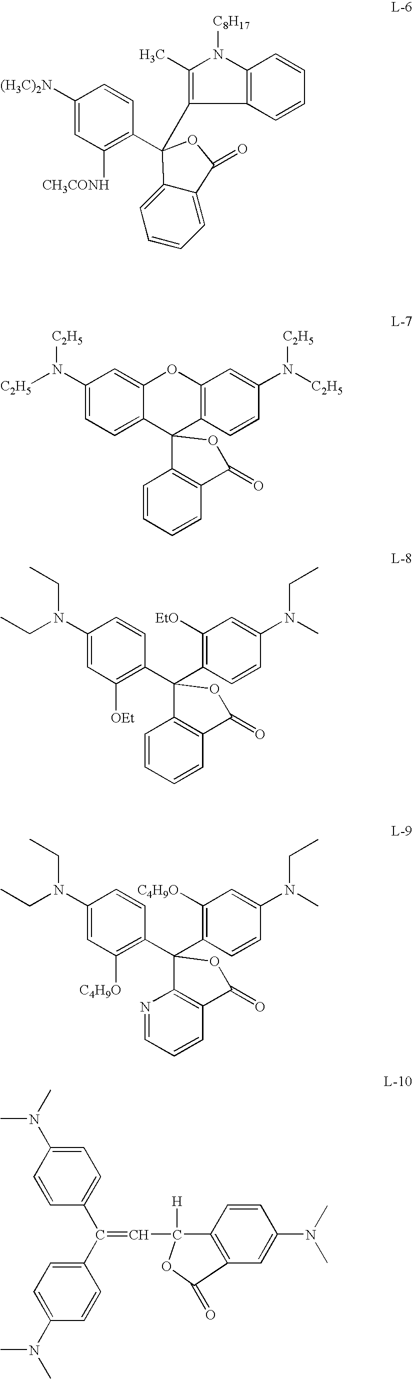

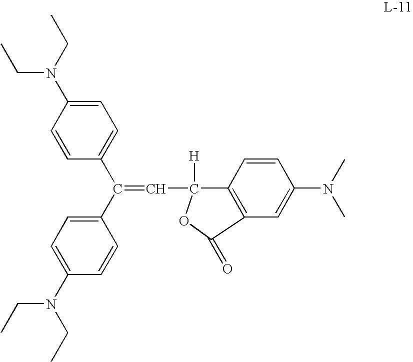

The cyanine-based compound (leucocyaine compound) is a compound which, when provided with an acid (proton), becomes a cyanine dye to develop color (shift to longer wavelength). This compound, too, is used as an electron-donating dye to advantage. The cyanine base preferably develops a color in the range of visible light or ultraviolet rays.

Preferred examples of the cyanine base will be given below, but the invention is not limited thereto.

| 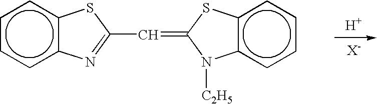 | 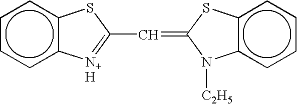 | |
|---|---|---|
| Cyanine base | | |
| (Leucocyanine dye), colorless | Cyanine dye (yellow) | |
| 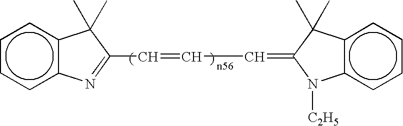 | LC-1 LC-2 LC-3 | n₅₆0 1 2 |
| 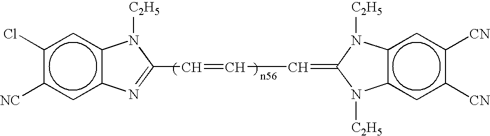 | LC-4 LC-5 LC-6 | n₅₆0 1 2 |
| 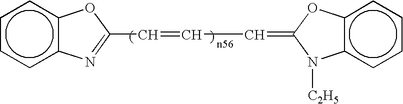 | LC-7 LC-8 | n₅₆0 1 |
| 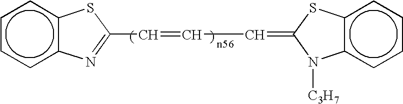 | LC-9 LC-10 | n₅₆0 1 |

| | |
|---|---|
| 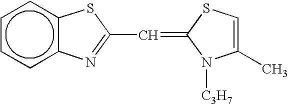 | 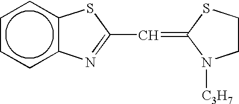 |
| LC-11 | LC-12 |
| 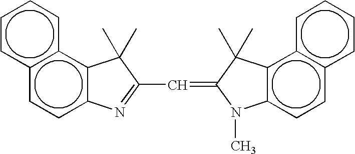 | 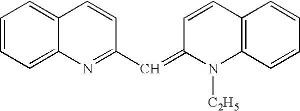 |
| LC-13 | LC-14 |

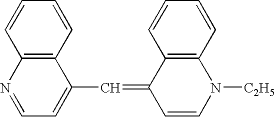

LC-15

The amount of the aforementioned electron-donating colorless dye to be used is preferably from 0.01 to 3 g/m², more preferably from 0.1 to 1 g/m². When the amount of the aforementioned electron-donating colorless dye to be used falls below 0.01 g/m², sufficient color density cannot be occasionally obtained. When the amount of the aforementioned electron-donating colorless dye to be used exceeds 3 g/m², the resulting coating solution can exhibit a deteriorated spreadability. The multi-layered recording layer, if used, is formed by laminating a plurality of recording layers comprising an electron-donating colorless dye incorporated therein in the above defined amount.

As the aforementioned diazonium salt compound there may be used a compound represented by the following general formula:
Ar—N₂⁺ X—
wherein Ar represents an aromatic ring group; and X— represents an acid anion.

The diazonium salt compound is a compound which, when heated, undergoes coupling reaction with a coupler to develop color or, when irradiated with light, to decompose. The diazonium salt compound can be controlled in its maximum absorption wavelength by the position or kind of substituents on Ar moiety.

In the aforementioned general formula. Ar represents a substituted or unsubstituted aryl group. Examples of the substituent on Ar include alkyl groups, alkoxy groups, alkylthio groups, aryl groups, aryloxy groups, arylthio groups, acyl groups, alkoxycarbonyl groups, carbamoyl groups, carbamide groups, sulfonyl groups, sulfamoyl groups, sulfonamide groups, ureido groups, halogen groups, amino groups, heterocyclic groups, nitro groups, and cyano groups. These substituents may be further substituted.

The aryl group represented by Ar is preferably a C6-C30 aryl group. Examples of the C6-C30 aryl group include phenyl groups, 2-methylphenyl groups, 2-chlorophenyl groups, 2-methoxyphenyl groups, 2-butoxyphenyl groups, 2-(2-ethylhexyloxy)phenyl groups, 2-octyloxyphenyl groups, 3-(2,4-di-t-pentylphenoxy ethoxy)phenyl groups, 4-chlorophenyl groups, 2,5-dichlorophenyl groups, 2,4,6-trimethylphenyl groups, 3-chlorophenyl groups, 3-methylphenyl groups, 3-methoxyphenyl groups, 3-butoxyphenyl groups, 3-cyanophenyl groups, 3-(2-ethylhexyloxy)phenyl groups, 3,4-dichlorophenyl groups, 3,5-dichlorophenyl groups, 3,4-dimethoxyphenyl groups, 3-dibutylaminocarbonylmethoxy)phenyl groups, 4-cyanophenyl groups, 4-methylphenyl groups, 4-methoxy phenyl groups, 4-butoxyphenyl groups, 4-(2-ethylhexyloxy)phenyl groups, 4-benzylphenyl groups, 4-aminosulfonylphenyl groups, 4N, N-dibutylaminosulfonylphenyl groups, 4-ethoxycarbonyl phenyl groups, 4-(2-ethylhexylcarbonyl)phenyl groups, 4-fluoroophenyl groups, 3-acetylphenyl groups, 2-acetylaminophenyl groups, 4-(4-chlorophenylthio)phenyl groups, 4-(4-methylphenyl)thio-2,5-butoxy phenyl groups, and 4-(N-benzyl-N-methylamino)-2-dodecyloxycarbonylphenyl groups.

These aryl groups may be further substituted by alkyloxy group, alkylthio group, substituted phenyl group, cyano group, substituted amino group, halogen atom, heterocyclic group or the like.

The maximum absorption wavelength λmax of the diazonium salt compound to be used in the invention is preferably 450 nm or less, more preferably frog 290 nm to 440 nm from the standpoint of effectiveness. The diazonium salt compound to be used in the invention is preferably a diazonium salt compound having 12 or more carbon atoms, a water solubility of 1% or less and an ethyl acetate solubility of 5% or more.

Specific preferred examples of the diazonium salt compound will be given below, but the invention is not limited thereto.

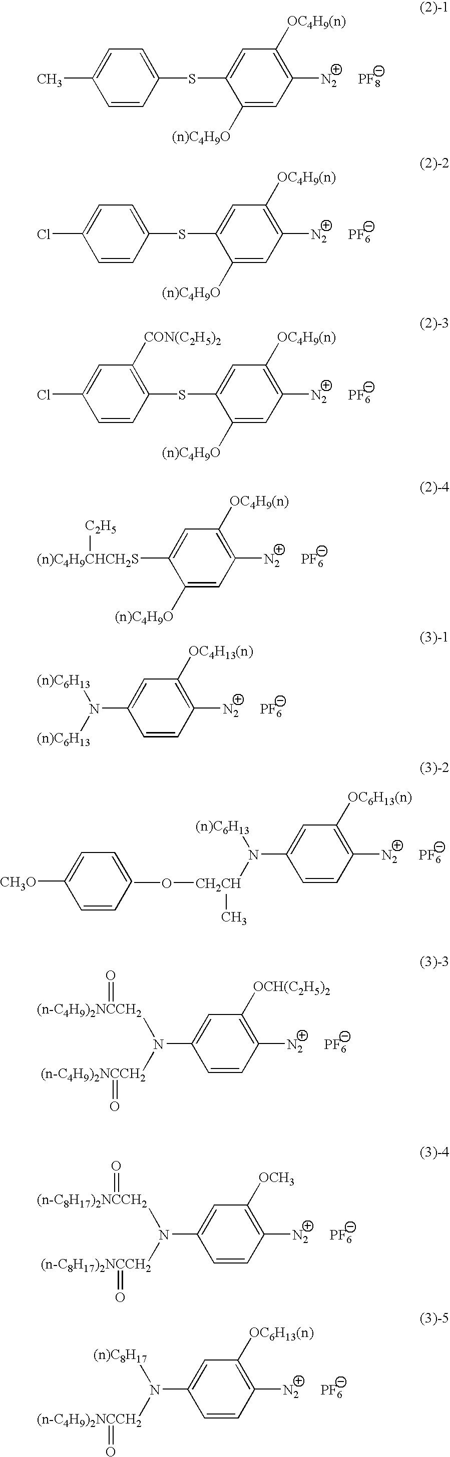

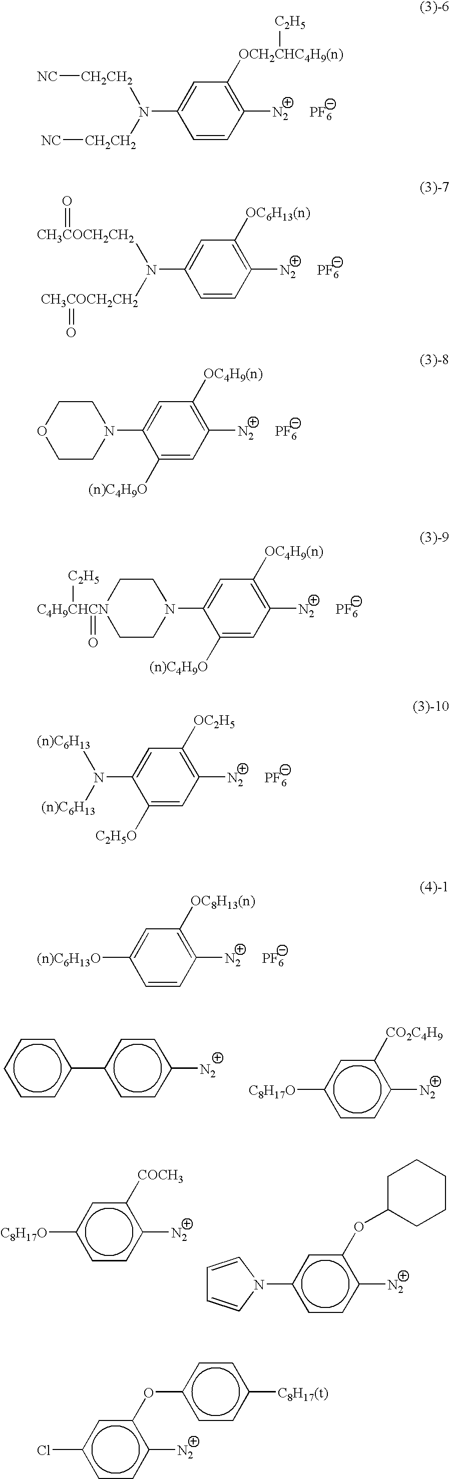

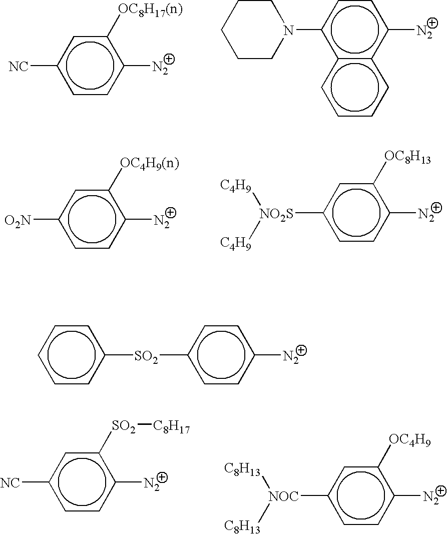

The aforementioned diazonium salt compounds may be used singly or in combination of two or more thereof depending on various purposes such as adjustment of hue.

The amount of the aforementioned diazonium salt compound to be incorporated in the photosensitive thermosensitive recording layer is preferably from 0.01 to 3 g/m², more preferably from 0.02 to 1.0 g/m². When the amount of the aforementioned diazonium salt compound to be incorporated in the photosensitive thermosensitive recording layer falls below 0.01 g/m², sufficient color developability cannot be occasionally obtained. When the amount of the aforementioned diazonium salt compound to be incorporated in the photosensitive thermosensitive recording layer exceeds 3 g/m², the resulting photosensitive thermosensitive recording layer exhibits a deteriorated sensitivity or occasionally needs to be fixed for a longer period of time. The multi-layered recording layer, if used, is formed by laminating a plurality of recording layers having an electron-donating colorless dye incorporated therein in the above defined amount.

The case where the two-photon absorption recording material of the invention is subject to color extinction reaction will be described hereinafter.

The combination of two components as such color-extinguishable components (color-extinguishable component A and compound causing color extinction) may be obtained by changing the color development reaction in the aforementioned combinations (a) to (r) to color extinction reaction. Particularly preferred among these or other combinations are the following combinations (in the following examples, the former indicates the color-extinguishable component and the latter indicates the compound causing color extinction.)

(s) Combination of oxidation type color-extinguishing agent and oxidizing agent;

(t) Combination of dissociation product of dissociative dye (acid color-extinguishable dye) and electron-donating compound (acid);

(u) Combination of electron-donating dye precursor color-developable material aid electron-donating compound (base); and

(v) Combination of radical color-extinguishable dye and radical generator

Particularly preferred among these combinations is (t) combination of dissociation product of dissociative dye (acid color-extinguishable dye) and electron-donating compound (acid). Preferred examples of dissociation product of dissociative dye (acid color-extinguishable dye) include dissociation product of dissociative benzylidene dye, dissociative oxonol dye, dissociative xanthene dye and dissociative azo dye. More desirable among these dissociation products of dissociative dye are dissociation product of dissociative benzylidene dye, dissociative oxonol dye and dissociative azo dye. The term “dissociative dye” as used herein is meant to indicate generically a dye having an active hydrogen having pKa of from about 2 to 14 such as —OH, —SH, —COOH, —NHSO2R and —CONHSO2R which shows absorption in a longer wavelength range or shift to higher ε when it releases proton. Accordingly, by treating a dissociative dye with a base so that it is dissociative, a dye which shows absorption in a longer wavelength range or shift to higher ε can be prepared. When a photo-acid is generated, such a dissociative dye can be rendered non-dissociative so that it undergoes color extinction (absorption in a shorter wavelength range or shift to lower ε).

Specific examples of the dissociation product of dissociative dye (acid color-extinguishable dye) of the invention will be given below, but the invention is not limited thereto.
<Dissociation Product of Dissociative Dye>

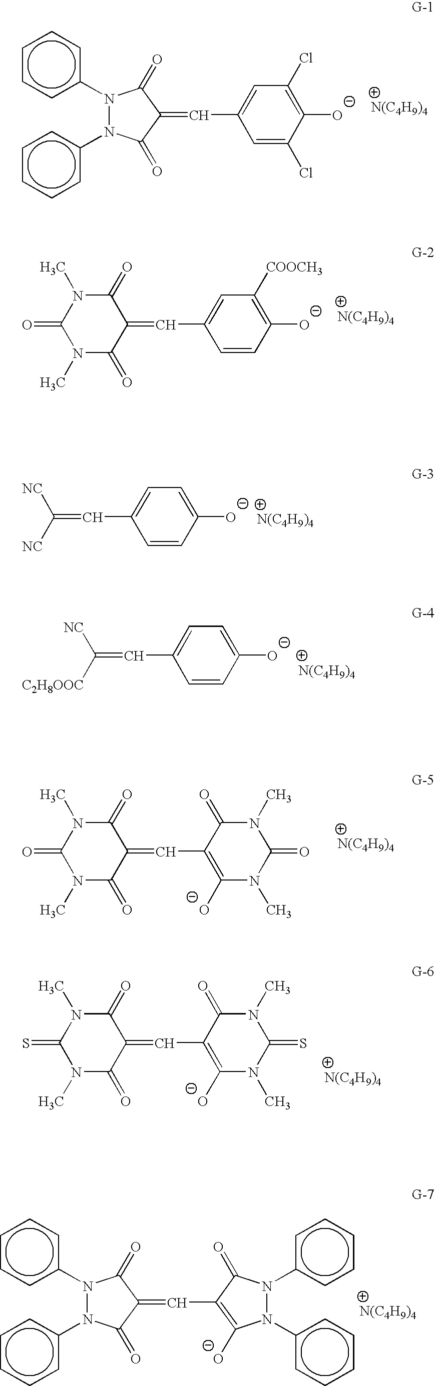

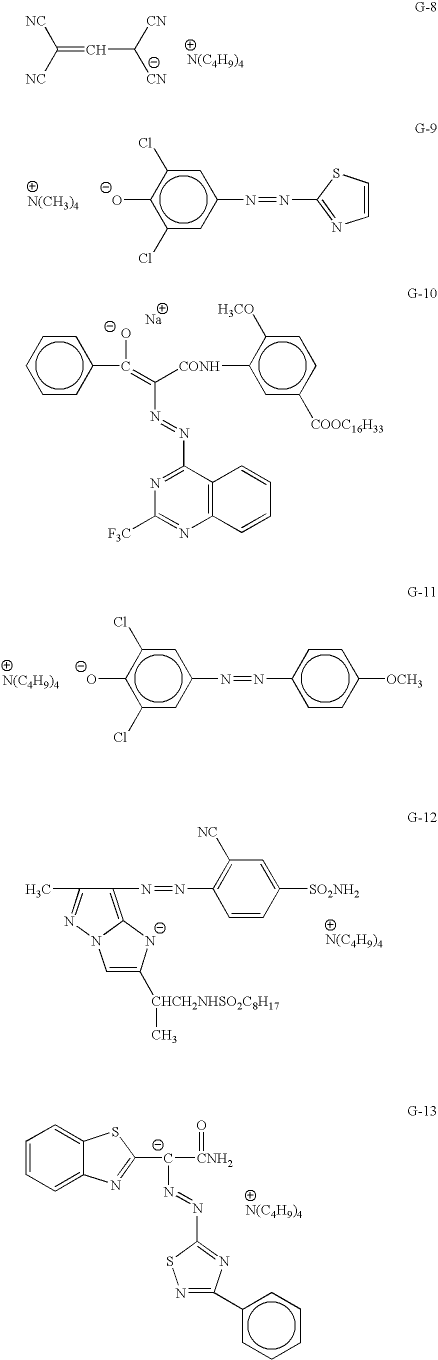

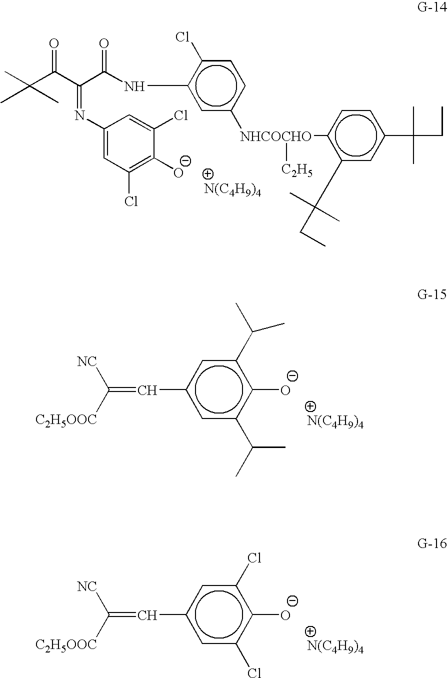

The two-photon absorption recording material of the invention preferably has the electron-donating colorless dye or diazonium salt compound (hereinafter occasionally referred to as “color-developable component), the dissociation product of dissociative dye precursor (hereinafter occasionally referred to as “color-extinguishable component”) or the like incorporated in a microcapsule. The microcapsulization of these components can be accomplished by any known method. Examples of such a method employable herein include a method involving the utilization of coacervation of hydrophilic wall-forming material disclosed in U.S. Pat. Nos. 2,800,457 and 2,800,458, an interfacial polymerization method disclosed in U.S. Pat. No. 3,287,154, British Patent 990,443, JP-B-38-19574, JP-B-42-446 and JP-B-42-771, a method involving polymer precipitation disclosed in U.S. Pat. Nos. 3,418,250 and 3,660,304, a method involving the use of isocyanate polyol wall material disclosed in U.S. Pat. No. 3,796,669 a method involving the use of isocyanate wall material disclosed in U.S. Pat. No. 3,914,511, a method involving the use of urea-formaldehyde-based and urea formaldehyde-resorcinol-based wall-forming materials disclosed in U.S. Pat. Nos. 4,001,140, 4,087,376 and 4,089,802, a method involving the use of wall-forming material such as melamine-formaldehyde resin and hydroxypropyl cellulose disclosed in U.S. Pat. No. 4,025,455, an in situ method involving the polymerization of monomer disclosed in JP-B-36-9168 and JP-A-51-9079) an electrolysis dispersion cooling method disclosed in British Patents 952807 and 965074, a spray drying method disclosed in U.S. Pat. No. 3,111,407 and British Patent 930,422, and a method disclosed in JP-B-7-73069, JP-A-4-101885, and JP-A-9-263057.

The microcapsulization of the components is not limited to the aforementioned methods. In particular, an interfacial polymerization method is preferably employed which comprises dissolving or dispersing a color-developable or color-extinguishable component in a hydrophobic organic solvent as a capsule core to prepare an oil phase, mixing the oil phase with an aqueous phase having a water-soluble polymer dissolved therein, subjecting the mixture to emulsion dispersion by a means such as homogenizer, and then heating the emulsion dispersion so that a polymer-forming reaction occurs at the oil droplet interface to form a microcapsule wall of polymer material. The aforementioned interfacial polymerization method allows the formation of capsule having a uniform particle diameter in a short period of time, making it possible to obtain a two-photon absorption recording material having an excellent preservability.

The microcapsule which is preferably used in the invention causes its microcapsule wall (hereinafter simply referred to as “capsule wall”) to separate materials from each other and prevent the interior material and the exterior material from coming into contact with each other at ordinary temperature but allows the interior material and the exterior material to come into contact with each other when heated aid/or pressured to not lower than a predetermined extent. This phenomenon can be freely controlled as a change of physical properties of capsule by property selecting the material of the capsule wall, the material of capsule core (material contained in capsule), the additives, etc.

The material of the capsule wall employable herein is incorporated in the interior and/or exterior of the oil droplet. Examples of the material of the aforementioned capsule wall include polyurethanes, polyureas, polyamides, polyesters, polycarbonates, urea-formaldehyde resins, melamine resins, polystyrenes, styrene methacrylate copolymers, and styrene-acrylate copolymers. Preferred among these materials am polyurethanes, polyureas, polyamides, polyesters, and polycarbonates. More desirable among these materials are polyurethanes and polyureas. These polymer materials may be used in combination of two or more thereof.

In the case where a polyurethane, for example, is used as a capsule wall material, a polyvalent isocyanate and a second material which reacts with the polyvalent isocyanate to formula capsule wall (e.g., polyol, polyamine) are mixed with an aqueous solution of a water-soluble polymer (aqueous phase) or an oil-soluble medium to be capsulized (oil phase). The mixture is then emulsion-dispersed in water. The emulsion dispersion is then heated so that a polymer-forming reaction occurs at the oil droplet interface to form a microcapsule wall. As the aforementioned polyvalent isocyanate and the polyol and polyamine which react therewith there may be used those disclosed in U.S. Pat. Nos. 3,281,383, 3,773,695 and 3,793,268, JP-B-48-40347, JP-B-49-24159. JP-A-48-80191, and JP-A-48-84086.

During the formation of microcapsule, the color-developable or color-extinguishable component to be incorporated in the microcapsule may be present in the form of solution or solid form in the capsule. In order to contain the color-developable or color-extinguishable component in the form of solution, an electron-donating colorless dye or diazonium salt compound which is a color-developable component and a dissociation product of dissociative dye which is a color extinguishable component may be capsulized in the form of solution in an organic solvent.

The aforementioned organic solvent can be normally properly selected from the group consisting of high boiling solvents. Examples of the high boiling solvent employable herein include phosphoric acid esters, phthalic acid esters, acrylic acid esters, methacrylic acid esters, other carboxylic acid esters, aliphatic acid amides, alkylated biphenyls, alkylated terphenyls, chlorinated paraffins, alkylated naphthalenes, diallyl ethanes, normally solid compounds, oligomer oils, and polymer oils. Specific examples of these high boiling solvents include organic solvents disclosed in JP-A-59-178451, JP-A-59-178452, JP-A-59-178453, JP-A-59-178454, JP-A-59-178455, JP-A-59-178457, JP-A-60-242094, JP-A-63-85633, JP-A-6-194825, JP-A-7-13310, JP-A-7-13311, JP-A-9-106039, and JP-A-63-045084 (Japanese Patent Application No. 62-75409). The amount of the aforementioned organic solvent to be used is preferably from 1 to 500 parts by mass based on 100 parts by mass of the electron-donating colorless dye or dissociation product of dissociative dye. The capsulization may be effected free from the aforementioned organic solvent. In other words, so-called oilless capsule may be formed.

In the case where the electron-donating colorless dye or the diazonium salt compound, dissociation product of dissociative dye, etc. have a low solubility in the aforementioned organic solvent, a low boiling solvent having a high dissolving power may be additionally used as an auxiliary solvent. On the other hand, the aforementioned low boiling solvent may be used instead of the aforementioned organic solvent. Examples of the aforementioned low boiling solvent include ethyl acetate, propyl acetate, isopropyl acetate, butyl acetate, and methylene chloride.

As the aqueous phase in which the aforementioned oil phase is emulsion-dispersed there is used an aqueous solution having a water-soluble polymer dissolved therein. The aqueous phase to which the oil phase has been added is then subjected to emulsion dispersion by means of a homogenizer or the like. The aforementioned water-soluble polymer acts as a protective colloid capable of uniformalizing and facilitating dispersion as well as a dispersion medium for stabilizing the emulsion-dispersed aqueous solution. In order that the emulsion dispersion might be affected more uniformly to obtain a stabler dispersion, at least one of the oil phase and the aqueous phase may have a surface active agent incorporated therein.

The water-soluble polymer to be incorporated in the aforementioned protective colloid may be properly selected from the group consisting of known anionic polymers, nonionic polymers and amphoteric polymers.

As the anionic polymer there may be used any of natural and synthetic anionic polymers. Examples of these anionic polymers include those having connecting groups such as —COO— and —SO₂—. Specific examples of these anionic polymers include natural materials such as gum arabic, alginic acid and pectine, gelatin derivatives such as carboxymethyl cellulose and phthalated gelatin, semi-synthetic products such as sulfated starch sulfated cellulose and ligninsulfonic acid, and synthetic products such as maleic anhydride-based copolymer (including hydrolyzate), acrylic acid-based (methacrylic acid-based) polymer and copolymer, vinylbenzenesulfonic acid-based polymer and copolymer and carboxy-modified polyvinyl alcohol.

Examples of the nonionic polymers include polyvinyl alcohols, polyvinyl pyrrolidones, hydroxyethyl celluloses, and methyl celluloses. Examples of the amphoteric polymers include gelatin. Preferred among these amphoteric polymers are gelatin, gelatin derivatives and polyvinyl alcohols. The aforementioned water-soluble polymer is used in the form of aqueous solution having a concentration of from 0.01 to 10% by mass.

The aforementioned surface active agent may be properly selected from the group consisting of known emulsifying surface active agents. For example, those which act as protective colloid to prevent precipitation or agglomeration as previously mentioned can be properly selected from the group consisting of anionic or nonionic surface active agents. Specific examples of these surface active agents include sodium alkylbenzene sulfonate, sodium alkylsulfate, dioctyl sodium sulfosuccinate, and polyalkylene glycol (e.g., polyoxyethylene nonyl phenyl ether). The amount of the aforementioned surface active agent to be incorporated is preferably from 0.1% to 5%, more preferably from 0.5% to 2% based on the mass of the oil phase.

All the ingredients, including color-developable and color-extinguishable components, may be used in the from of a solid dispersion with, e.g., a water-soluble polymer, a sensitizer and other color-developable or color-extinguishable components obtained using a sandmill or other means. However, it is preferred that all these ingredients be dissolved in a difficulty water-soluble or water-insoluble high boiling organic solvent mixed with an aqueous solution of a polymer (aqueous phase) containing a surface active agent and/or a water-soluble polymer, and then emulsified using a homogenizer or the like to form an emulsion dispersion. In this case, a low boiling solvent may be used as a dissolving aid as necessary. Further, all the ingredients, including color-developable and color-extinguishable components, may be separately emulsion-dispersed. Alternatively, all these ingredients may be mixed, dissolved in a high boiling solvent and/or a low boiling solvent, and then emulsion dispersed. The resulting emulsion dispersion preferably has a particle diameter of 1 μm or less.

The aforementioned emulsion dispersion can be easily attained by subjecting an oil phase containing the aforementioned components and an aqueous phase containing a surface active agent and/or a protective colloid to emulsion dispersion using a means for fine emulsification such as high speed agitation and ultrasonic dispersion, e.g., known emulsifier such as homogenizer, Manton-Gaulin, ultrasonic dispersing machine, dissolver and KD mill.

The emulsion thus obtained is then heated to a temperature of from 30° C. to 70° C. for the purpose of accelerating the capsule wall-forming reaction. During the reaction, it is necessary that water be added to the reaction mixture to lower the provability of collision of capsules to each other or be thoroughly stirred so that the agglomeration of capsules can be prevented. On the other hand, a dispersion for preventing agglomeration may be separately added during the reaction. The end point of the aforementioned capsule wall-forming reaction can be roughly recognized by the termination of the generation of carbon dioxide gas observed with the progress of the polymerization reaction. In general, the capsule wall-forming reaction can be effected for several hours to obtain a microcapsule having a color-developable or color-extinguishable component incorporated therein.

In the invention, the average particle diameter of the microcapsules is preferably 1 μm or less, more preferably 0.5 μm or less, most preferably 0.2 μm or less from the standpoint of enhancement of resolution (diffraction efficiency).

As the substantially colorless compound B comprising a polymerizable group having an ethylenically unsaturated bond and a site which reacts with the aforementioned color-developable or color-extinguishable component A to cause color development or color extinction in the same molecule, which compound B to be incorporated in the photosensitive thermosensitive recording layer in the two-photon absorption recording material of the invention, there may be any compound which is capable of reacting with the aforementioned color-developable or color-extinguishable component A to cause color development or color extinction as well as reacting with light to cause polymerization and curing, such as electron-accepting compound having a polymerizable group and coupler compound having a polymerizable group.

As the electron-accepting compound having a polymerizable group, i.e., compound having an election-accepting group and a polymerizable group in the same molecule, there may be used any compound which reacts with an electron-donating colorless dye which is one of the aforementioned color-developable components A to develop color or reacts with a dissociation product of dissociative dye which is one of the aforementioned color-extinguishable components A to extinguish color and undergoes photopolymerization to cure the film. Examples of the aforementioned electron-accepting compound include 3-halo-4-hydroxybenzoic acids disclosed in JP-A-4-226455, methacryloxyethyl esters and acryloxyethyl esters of benzoic acid having hydroxyl group disclosed in JP-A-63-173682, esters of benzoic acid with hydroxymethylstyrene having hydroxyl group disclosed in JP-A-59-83693, JP-A-60-141587 and JP-A-62-99190, hydroxystyrenes disclosed in EP 29323, N-vinylimidazole complexes of halogenated zinc disclosed in JP-A-62-167077 and JP-A-62-16708, and compounds which can be synthesized according to electron-accepting compounds disclosed in JP-A-63-317558. Preferred among these compounds having au electron-accepting group and a polymerizable group in the same molecule are 3-halo-4-hydroxybenzoic acids represented by the following general formula: 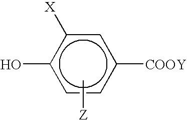
wherein X represents a halogen atom, preferably chlorine atom; Y represents a monovalent group having a polymerizable ethylene group, preferably aralkyl, acryloyloxyalkyl or methacryloyloxyalkyl group having vinyl group, more preferably C5-C11 acryloyloxyalkyl group or C6-C12 methacryloyloxyalkyl group; and Z represents a hydrogen atom, alkyl group or alkoxyl group.

Examples of the aforementioned 3-halo-4-hydroxy benzoic acids include 3-chloro-4-hydroxybenzoic acid ester vinyl phenethyl ester, 3-chloro-4-hydroxybenzoic acid vinyl phenyl propyl ester, 3-chloro-4-hydroxy benzoic acid-(2-acryloyloxyethyl)ester, 3-chloro-4-hydroxybenzoic acid-(2-methacryloyloxyethyl)ester, 3-chloro-4-hydroxybenzoic acid-(2-acryloyloxypropyl) ester, 3-chloro-4-hydroxybenzoic acid-(2-methacryloyl oxypropyl)ester, 3-chloro-4-hydroxybenzoic acid-(3-acryloxypropyl)ester, 3-chloro-4-hydroxybenzoic acid-(3-methacryloyloxypropyl)ester, 3-chloro-4-hydroxybenzoic acid-(4-acryloyloxybutyl) ester, 3-chloro-4-hydroxybenzoic acid-(4-methacryloyloxybutyl)ester, 3-chloro-4-hydroxybenzoic acid-(5-acryloyloxypentyl)ester, 3-chloro-4-hydroxybenzoic acid-(5-methacryloyloxypentyl)ester, 3-chloro-4-hydroxybenzoic acid-(6-acryloyloxyhexyl)ester, 3-chloro-4-hydroxybenzoic acid-(6-methacryloxyhexyl) ester, 3-chloro-4-hydroxybenzoic acid-(8-acryloyloxy octyl)ester, and 3-chloro-4-hydroxybenzoic acid-(8-methacryloyloxyoctyl)ester.

Further examples of preferred compound having an electron-accepting group and a polymerizable group in the same molecule include styrenesulfonylaminosalicylic acid, vinylbenzyloxyphthalic acid, zinc β-methacryloxyethoxysalicylate, zinc β-acryloxyethoxysalicylate, vinyloxyethyloxybenzoic acid, β-methacryloxyethylorselinate, β-acryloxyethylorsclinate, β-methacryloxy ethoxy phenol, β-acryloxyethoxy phenol, β-methacryloxy ethyl-β-resorcinate, β-acryloxyethyl-β-resorcinate, hydroxystyrenesulfonic acid-N-ethylamide, β-methacryloxypropyl-p-hydroxybenzoate, β-acryloxy propyl-p-hydroxybenzoate, methacryloxymethylphenol, acryloxymethylphenol, methacrylamidepropanesulfonic acid, acrylamidepropanesulfonic acid, β-methacryloxy ethoxy-dihydroxybenzene, β-acryloxyethoxy-dihydroxybenzene, γ-styrenesulfonyloxy-β-methacryloxy propanecarboxylic acid, γ-acryloxypropyl-α-hydroxyethyloxysalicylic acid, β-hydroxyethoxyphenol, β-methacryloxyethyl-p-hydroxy cinnamate, β-acryloxyethyl-p-hydroxy cinnamate, 3,5-distyrenesulfonic acid amidephenol, methacryloxyethoxy phthalic acid, acryloxyethoxyphthalic acid, methacrylic acid, acrylic acid, methacryloxyethoxyhydroxynaphtoic acid, acryloxyethoxyhydroxynaphtoic acid, 3-β-hydroxy ethoxyphenol, β-methacryloxyethyl-p-hydroxybenzoate, and β-acryloxyethyl-p-hydroxybenzoate, β′-methacryloxyethyl-β-resorcinate, β-methacryloxy ethyloxycarbonylhydroxybenzoic acid, β-acryloxy ethyloxycarbonylhydroxybenzoic acid, N,N′-di-β-methacryloxyethylaminosalicylic acid, N,N′-di-β-acryloxyethylaminosalicylic acid, N,N′-di-β-methacryloxyethylaminosulfonylsalicylic acid, N,N′-di-β-acryloxyethylaminosulfonylsalicylic acid, and salts thereof with metal (e.g., zinc).

The aforementioned election-accepting compound having a polymerizable group is used in combination with the aforementioned electron-donating colorless dye or dissociation product of dissociative dye. In this case, the amount of the electron-accepting compound to be used is preferably from 0.5 to 20 parts by mass, more preferably from 3 to 10 parts by mass based on 1 part by mass of the electron-donating colorless dye or dissociation product of dissociative dye used. When the amount of the electron-accepting compound to be used falls below 0.5 parts by mass, the resulting color development or color extinction, i.e., refractive index modulation cannot be sufficient. When the amount of the electron-accepting compound to be used exceeds 20 parts by mass, it can occasionally cause the drop of sensitivity or the deterioration of spreadability.

As the aforementioned coupler compound having a polymerizable group there may be used any compound having a polymerizable group which can react with a diazonium salt compound as one of the aforementioned color-developable components A to cause color development and undergo photopolymerization to cure the film. The coupler compound undergoes coupling with a diazo compound in a basic atmosphere and/or neutral atmosphere to form a dye. A plurality of such coupler compounds may be used in combination depending on various purposes such as hue adjustment. Specific examples of these coupler compounds will be given below, but the invention is not limited thereto.

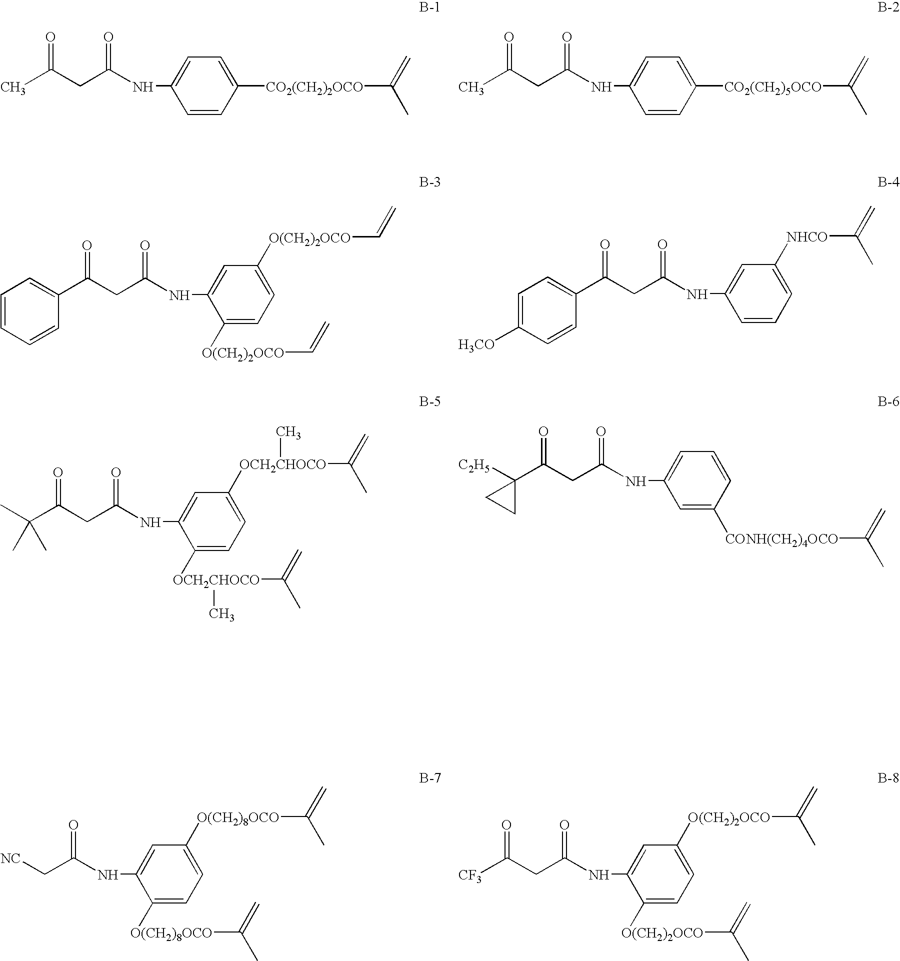

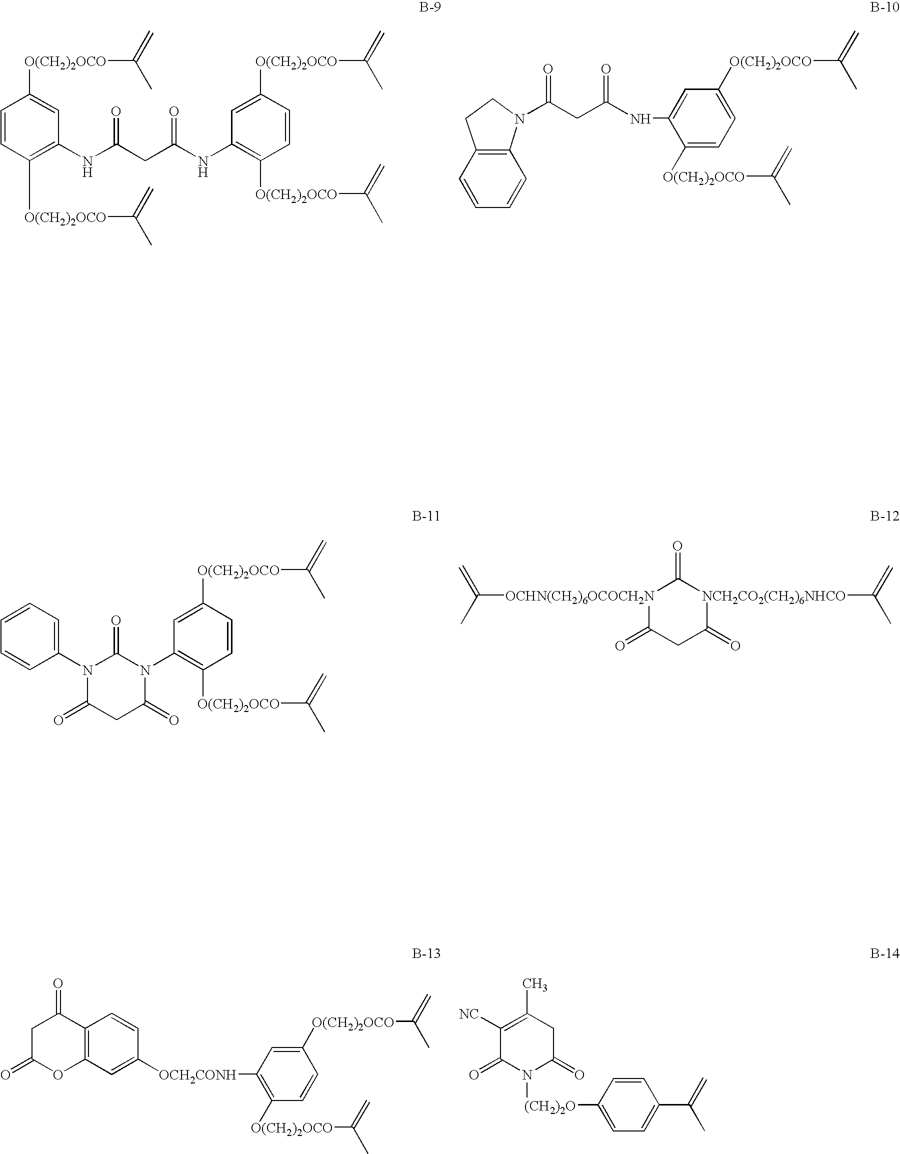

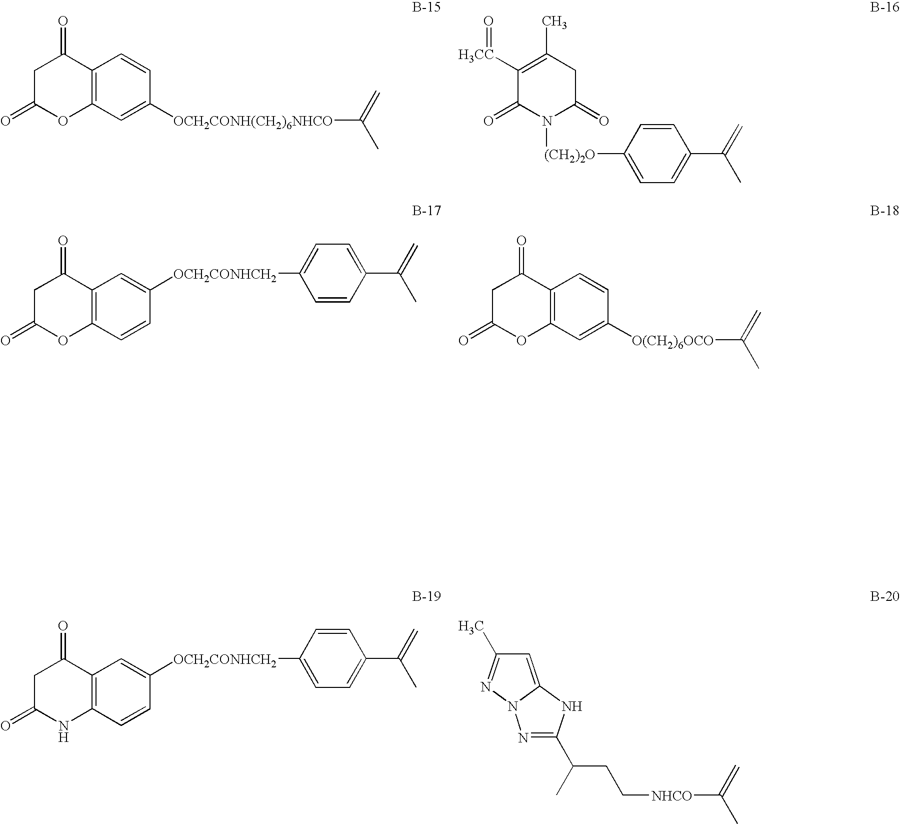

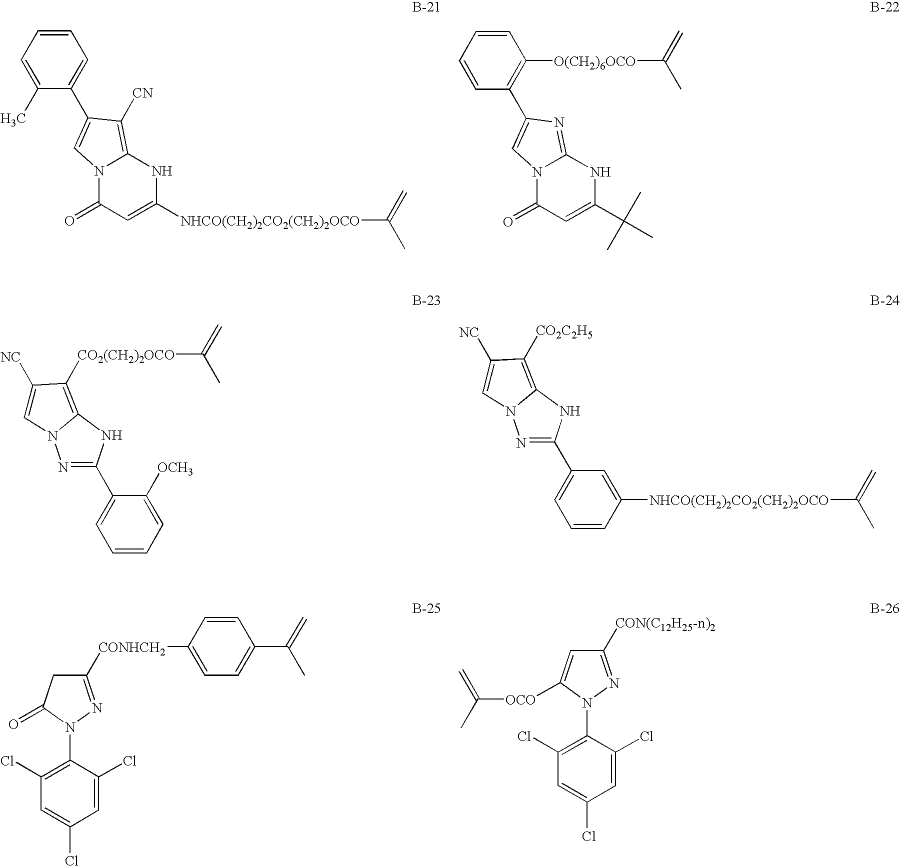

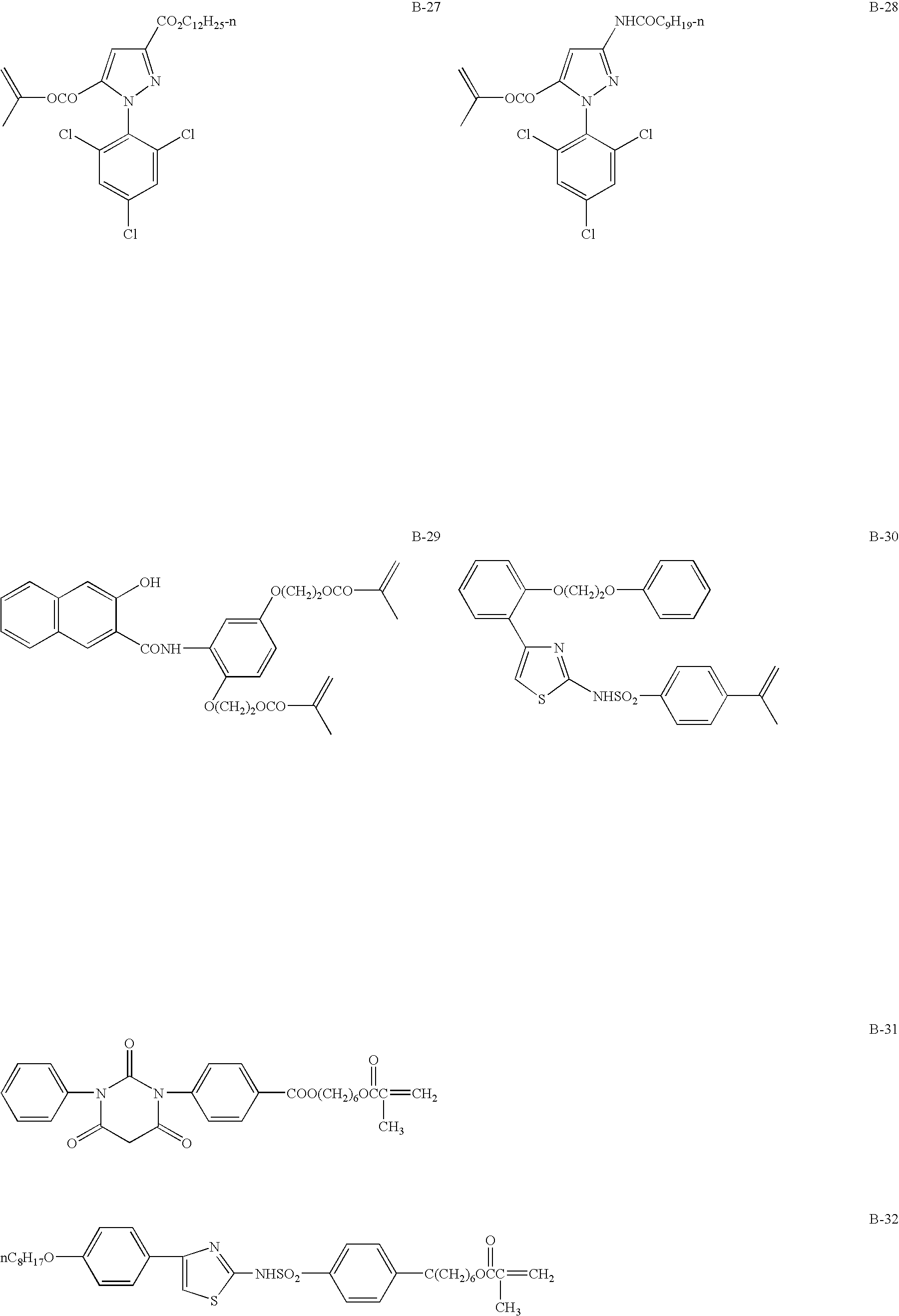

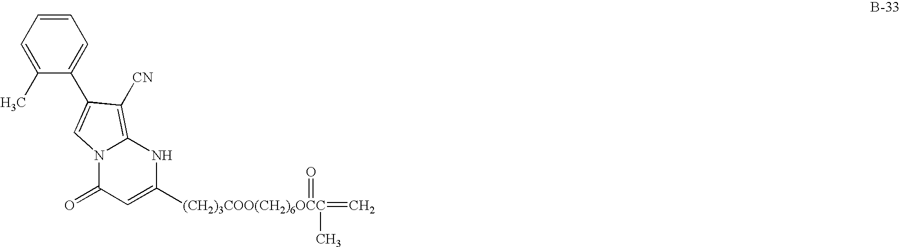

The aforementioned coupler compound is used in combination with the diazonium salt compound. The amount of the aforementioned coupler compound to be incorporated in the photosensitive thermosensitive recording layer in the two-photon absorption recording material of the invention is preferably from 0.02 to 5 g/m² more preferably from 0.1 to 4 g/m² from the standpoint of effectiveness. When the amount of the coupler compound to be incorporated in the photosensitive thermosensitive recording layer falls below 0.02 g/m², the resulting two-photon absorption recording material occasionally exhibits deteriorated color developability. When the amount of the coupler compound to be incorporated in the photosensitive thermosensitive recording layer exceeds 5 g/m², the resulting coating solution occasionally exhibits deteriorated spreadability.

The amount of the coupler compound to be used is preferably from 0.5 to 20 parts by mass, more preferably from 1 to 10 parts by mass based on 1 part by mass of the diazonium salt compound. When the amount of the coupler compound to be used falls below 0.5 parts by mass, the resulting color development, i.e., refractive index-, absorptivity- or luminescence intensity-modulation cannot be sufficient. When the amount of the coupler compound to be used exceeds 20 pans by mass, the coating solution occasionally exhibits deteriorated spreadability.

The coupler compound may be used in the form of a solid dispersion obtained by dispersing the coupler compound with other components and a water-soluble polymer using a sandmill or the like. Alternatively, the coupler compound may be used in the form of an emulsion obtained by emulsifying the coupler compound with an auxiliary emulsifier. The solid dispersion or emulsification method is not specifically limited and may be properly selected from the group consisting of known methods. For the details of these methods, reference can be made it JP-A-59-190886, JP-A-2-141279, and JP-A-7-17145.

For the purpose of accelerating coupling reaction, an organic base is preferably used. Examples of the organic base employable herein include tertiary amines, piperidines, piperidines, amidines, formamidines, pyridines, guanidines, and morpholines disclosed in JP-A-57-123086, JP-A-60-49991, JP-A-60-94381, JP-A-9-71048 (Japanese Patent Application No. 7-228731), JP-A-9-77729 (Japanese Patent Application No. 7-235157), and JP-A-9-77737 (Japanese Patent Application No. 7-235158). The aforementioned organic bases may be used singly or in combination of two or more thereof. The amount of the organic base to be used is not specifically limited but is preferably from 1 to 30 tools per mol of diazonium salt.

Further, a color development or color extinction aid may be added for the purpose of accelerating the color development or color extinction reaction. Examples of the aforementioned color development or color extinction and include phenol derivatives, naphthol derivatives, alkoxy-substituted benzenes, alkoxy-substituted naphthalenes, hydroxy compounds, carboxylic acid amide compounds, and sulfonamide compounds. It is thought that these compounds act to cause the drop of the melting point of the coupler compound or basic material or enhance the heat permeability of the microcapsule wall, making it possible to obtain a high density of color developed or extinguished, i.e., high refractive index-, absorptivity- or luminescence intensity-modulation.

In the invention, instead of the compound B having a polymerizable group as the compound which reacts with the aforementioned color-developable or color-extinguishable component A to cause color development or color extinction there may be used a substantially colorless polymerizable group-free compound C which reacts with the color-developable or color-extinguishable component A to cause color development or color extinction instead of the aforementioned compound having a polymerizable group. However, since the aforementioned compound C is free of polymerizable group, it is used in combination with a substantially colorless compound D having a polymerizable group having at least one ethylenically unsaturated bond and a site which inhibits the reaction of the aforementioned color-developable or color-extinguishable component A with the compound C in the same molecule (hereinafter occasionally referred to as “compound D having polymerizable group”) for the purpose of rendering the recording layer capable of curing by photopolymerization.

As the aforementioned compound D having a polymerizable group there may be used the already described photopolymerizable monomer D1 or D2. Any suitable compound D may be properly used depending on the kind of the compound C which is incorporated as a color-developable or color-extinguishable component. Combinations of the compound C which is incorporated as a color-developable or color-extinguishable component and the compound D adapted for the compound C will be successively described later.

As the aforementioned compound C there may be used any electron-accepting compound or coupler compound free of polymerizable group. As the electron-accepting compound free of polymerizable group there may be used any compound which can react with an electron-donating colorless dye or dissociation product of dissociative dye which is one of the aforementioned color-developable or color-extinguishable components A to cause color development or color extinction.

Examples of the electron-accepting compound free of polymerizable group include phenol derivatives, salicylic acid derivatives, metal salts of aromatic carboxylic acid, acidic clay, bentonite, novolac resins, metal-treated novolac resins, and metal complexes. For the details of these electron-accepting compounds free of polymerizable group, reference can be made to JP-B-40-9309, JP-B-45-14039, JP-A-52-140483, JP-A-48-51510. JP-A-57-210886, JP-A-58-87089, JP-A-59-11286, JP-A-60-116795, and JP-A-61-95988.

Specific examples of the aforementioned compounds will be given below. Examples of the phenol derivatives include 2,2′-bis(4-hydroxyphenyl)propane, 4-t-butyl phenol, 4-phenylphenol, 4-hydroxydiphenoxide, 1,1′-bis(3-chloro-4-hydroxyphenyl)cyclohexane, 1,1′-bis(4-hydroxyphenyl)cyclohexane, 1,1′-bis(3-chloro-4-hydroxyphenyl)-2-ethylbutane, 4,4′-sec-isooctylidene diphenyl, 4,4′-sec-butylidenediphenol, 4-tert-octyl phenol, 4-p-methylphenylphenol, 4,4′-methylcyclohexylidenephenol, 4,4′-isopentylideneplienol, and p-hydroxybenzoic acid benzyl.

Examples of the salicylic acid derivatives include 4-pentadecylsalicylic acid, 3,5-di(α-methylbenzyl) salicylic acid, 3,5-di(tert-octyl)salicylic acid, 5-octadecylsalicylic acid, 5-α-(p-α-methylbenzylphenyl)ethylsalicylic acid, 3-α-methylbenzyl-5-tert-octyl salicylic acid, 5-tetradecylsalicylic acid, 4-hexyloxy salicylic acid, 4-cyclohexyloxysalicylic acid, 4-decyl oxysalicylic acid, 4-dodecyloxysalicylic acid, 4-pentadecyloxysalicylic acid, 4-octadecyloxysalicyclic acid, and salts thereof with zinc, aluminum, calcium, copper and lead.

The amount of the aforementioned electron-accepting compound free of polymerizable group to be used is preferably from 5 to 1,000% by mass based on the amount of the electron-donating colorless dye to be used.

In the case where the aforementioned electron-accepting compound free of polymerizable group is used, the already described photopolymerizable monomer D1 is additionally used as the compound D having a polymerizable group. The aforementioned photopolymerizable monomer D1 is preferably a photopolymerizable monomer having at least one vinyl group per molecule which acts to inhibit the reaction of the electron-donating colorless dye with the electron-accepting compound.

The amount of the aforementioned photopolymerizable monomer D1 to be incorporated in the photosensitive thermosensitive recording layer in the two-photon absorption recording material of the invention is preferably from 0.1 to 10 parts by mass, more preferably from 0.5 to 5 parts by mass based on 1 part by mass of the substantially colorless compound C which reacts with the aforementioned color-developable or color-extinguishable component A to cause color development or color extinction. When the amount of the aforementioned photopolymerizable monomer D1 to be incorporated in the photosensitive thermosensitive recording layer falls below 0.1 parts by mass, a latent image cannot be occasionally formed at the holographic exposure step. When the amount of the aforementioned photopolymerizable monomer D1 to be incorporated in the photosensitive thermosensitive recording layer exceeds 10 parts by mass, the density of color developed or extinguished, i.e., refractive index-, absorptivity- or luminescence intensity-modulation can be lowered.

As the aforementioned coupler compound free of polymerizable group there may be used any compound which can react with a diazonium salt compound which is one of the aforementioned color-developable components A to cause color development. The coupler compound free of polymerizable group undergoes coupling with the diazonium compound in a basic atmosphere and/or neutral atmosphere to form a dye. A plurality of these coupler compounds can be used depending on various purposes such as hue adjustment.

Examples of the coupler compound free of polymerizable group include so-called active methylene compounds having methylene group adjacent to carbonyl group, phenol derivatives, and naphthol derivatives. These coupler compounds may be properly selected so far as they comply with the aim of the invention.

Examples of the aforementioned coupler compounds free of polymerizable group include resorcine, Phloroglucin, 2,3-dihydroxynaphthalene, sodium 2,3-dihydroxy naphthalene-6-sulfonate, 1-hydroxy-2-naphtoic acid morpholinopropylamide, sodium 2-hydroxy-3-naphthalenesulfonate. 2-hydroxy-3-naphthalene sulfonic acid anilide, 2-hydroxy-3-naphthalenesulfonic acid morpholinopropylamide, 2-hydroxy-3-naphthalene sulfonic acid-2-ethylhexyloxypropylamide, 2-hydroxy-3-naphthalenesulfonic acid-2-ethylhexylamide, 5-acetamide-1-naphthol, sodium 1-hydroxy-8-acetamidenaphthalene-3,6-disulfonate, 1-hydroxy-8-acetamidenaphthalene-3,6-disulfonic acid anilide, 1,5-dihydroxynaphthalene, 2-hydroxy-3-naphthoic acid morpholinopropylamide, 2-hydroxy-3-naphthoic acid octylamide, 2-hydroxy-3-naphthoic acid anilide, 5,5-dimethyl-1,3-cyclohexane dione, 1,3-cyclopentadione, 5-(2-n-tetradecyloxy phenyl)-1,3-cyclohexanedione, 5-phenyl-4-methoxy carbonyl-1,3-cyclohexanedione, 5-(2,5-di-n-octyloxy phenyl)-1,3-cyclohexanedione, N,N′-dicyclohexyl barbituric acid, N,N′-di-n-dodecylbarbituric acid, N-n-octyl-N′-n-octadecylbarbituric acid, N-phenyl-N′-(2,5-di-n-octyloxyphenyl)barbituric acid, N,N′-bis(octadecyloxycarboylmethyl)barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamide-5-pyrazolone, 6-hydroxy-4-methyl-3-cyano-1-(2-ethylhexyl)-2-pyridone, 2,4-bis(benzoylacetamide) toluene, 1,3-bis(pivaolylacetamidemethyl)benzene, benzoylacetonitrile, tenoylacetonitrile, acetoacetoanilide, benzoylacetoanilide, pivaloylacetoanilide, 2-chloro-5-(N-n-butylsulfamoyl)-1-pivaloylacetamidebenzene, 1-(2-ethylhexyloxy propyl)-3-cyano-4-methyl-6-hydroxy-1,2-dihydro pyridine-2-one, 1-(dodecyloxypropyl)-3-acetyl-4-methyl-6-hydroxy-1,2-dihydropyridine-2-one, and 1-(4-n-octyloxyphenyl)-3-tert-butyl-5-aminopyrazole.

For the details of the coupler compound free of polymerizable group, reference can be made to JP-A-4-201483, JP-A-7-223367, JP-A-7-223368, JP-A-7-323660, JP-A-5-278608, JP-A-5-297024, JP-A-6-18669, JP-A-6-18670, and JP-A-7-316280. Reference can be made also to JP-A-9-216468 (Japanese Patent Application No. 8-027095), JP-A-9-216469 (Japanese Patent Application No. 8-027096), Japanese Patent Application No. 8-030799, JP-A-9-319025 (Japanese Patent Application No. 8-132394), JP-A-10-35113 (Japanese Patent Application No. 8-358755), JP-A-10-193801 (Japanese Patent Application No. 8-358756) and JP-A-10-264532 (Japanese Patent Application No. 9-069990), which have been early filed by the present applicant.

The amount of the coupler compound tree of polymerizable group to be incorporated in the photosensitive thermosensitive recording layer of the two-photon absorption recording material of the invention is the same as that of the coupler compound having a polymerizable group. The coupler compound free of polymerizable group may be used in the form of solid dispersion or emulsion similarly to the aforementioned coupler compound having a polymerizable group. The solid dispersion or emulsification of the coupler compound free of polymerizable group can be carried out by the same method as that of the coupler compound having a polymerizable group. For the purpose of accelerating the coupling reaction, the same organic base as used in the case of the aforementioned coupler compound having a polymerizable group may be used in the same amount as defined in that case. As the color development aid to be used for the purpose of accelerating the color development reaction there may be used the same compound as used in the case of the aforementioned coupler compound having a polymerizable group.

The aforementioned coupler compound free of polymerizable group, if any, is used in combination with the already described photopolymerizable monomer D2 as compound D having a polymerizable group D. The aforementioned photopolymerizable monomer D2 is preferably a photopolymerizable monomer which has an acidic group having an effect of inhibiting the coupling reaction and is not a metal salt compound. The amount of the aforementioned photopolymerizable monomer D2 to be incorporated in the photosensitive thermosensitive recording layer is the same as in the case of the aforementioned photopolymerizable monomer D1.

The photosensitive thermosensitive recording layer of the two-photon absorption recording material of the invention comprises a photopolymerization initiator incorporated therein besides the aforementioned color-developable or color-extinguishable component A, compound B or compound C or D. As the photopolymerization initiator there may be used the same photopolymerization initiator as can be used in the aforementioned photopolymerizable composition. The amount of the spectral sensitizing dye to be incorporated in the photosensitive thermosensitive recording layer is preferably from 0.1 to 5% by mass, more preferably from 01 to 2% by mass based on the total dried mass of the photosensitive thermosensitive recording layer.

As the compound having mutual interaction with the spectral sensitizing dye in the photopolymerization initiator there may be used one or more properly selected from the group consisting of known compounds capable of initiating the photopolymerization reaction with the photopolymerizable group in the aforementioned compound B or the compound D (photopolymerizable monomer D1, D2). In some detail, the compound having mutual interaction with the spectral sensitizing dye can be properly selected from the already described compounds. Referring to the amount of the compound having mutual interaction with the spectral sensitizing dye to be used, the compound having mutual interaction with the spectral sensitizing dye may be used in the predetermined mixing ratio with the spectral sensitizing dye in the photopolymerization initiator contained in the aforementioned photopolymerizable composition as already described. Further, the photosensitive thermosensitive recording layer may comprise already described other components usable in the photopolymerizable composition incorporated therein.

The embodiment of the two-photon absorption recording material having a photosensitive thermosensitive recording layer provided on a support as mentioned above is not limited to the aforementioned photosensitive thermosensitive two-photon absorption recording material (a) or (b) but may have various configurations depending on the purpose. The other words, the two-photon absorption recording material may undergo not only monochromatic refractive index modulation but also polychromatic refractive index modulation. Further, if necessary, a protective layer may be provided on the outermost layer, that is on the photosensitive thermosensitive recording layer, i.e., on the side of the two-photon absorption recording material on which light is incident. The aforementioned polychromatic two-photon absorption recording material may be a multi-layered two-photon absorption recording material having a plurality of monochromatic recording layers stacked. An interlayer may be provided interposed between these recording layers. The aforementioned protective layer may have a single layer structure or a stacked structure having two or more layers stacked.

Examples of the material of the aforementioned protective layer include water-soluble polymer compounds such as gelatin, polyvinyl alcohol, carboxy-modified polyvinyl alcohol, vinyl acetate-acrylamide copolymer, silicon-modified polyvinyl alcohol, starch, modified starch, methyl cellulose, carboxymethyl cellulose, hydroxymethyl cellulose, gelatin, gum arabic, casein, hydrolyzate of styrene-maleic acid copolymer, hydrolyzate of styrene-maleic acid copolymer half ester, hydrolyzate of isobutylene-maleic anhydride copolymers polyacrylamide derivative, polyvinyl pyrrolidone, sodium polystyrenesulfonate and sodium alginate, and latexes such as styrene-butadiene rubber latex, acrylonitrile-butadiene rubber latex, methyl acrylate-butadiene rubber latex and vinyl acetate emulsion.

By crosslinking the water-soluble polymer compound incorporated in the aforementioned protective layer, the storage stability of the two-photon absorption recording material can be further enhanced. As the crosslinking agent to be used in crosslinking there may be used any known crosslinking agent. Specific examples of the crosslinking agents include water-soluble initial condensates such as N-methylolurea, N-methylolmelamine and urea-formaline, dialdehyde compounds such as glyoxal and glutaraldehyde, inorganic crosslinking agents such as boric acid and borax, and polyamideepichlorohydrin.

The aforementioned protective layer may further comprise a known pigment, metal soap, wax, surface active agent fluorescent brightening agent, etc. incorporated therein. Further, a UV absorber or UV absorber precursor such as hydroxyphenylbenzotriazole-based compound, hydroxybenzophenone-based compound and hydroxyphenyl triazine-based compound may be added.

The spread (dried) of the aforementioned protective layer is preferably from 0.2 to 5 g/m², more preferably from 0.5 to 3 g/m².

The polychromatic two-photon absorption recording material, if used, can be formed by laminating a plurality of monochromatic recording layers on each other on a support. By incorporating in the various recording layers microcapsules containing color-developable or color-extinguishable components having different hues of color developed or extinguished and photopolymerizable compositions which are sensitive to light having different wavelengths, a polychromatic multilayered two-photon absorption recording material can be formed. When irradiated with light, the various recording layers are sensitive to light having respective wavelength. As a whole, refractive index-, absorptivity or luminescence intensity-modulation by polychromatic color development is recorded. The aforementioned photopolymerizable composition comprises spectral sensitizing dyes having different absorption wavelengths so that it is sensitive to light having different wavelengths. In this case, an interlayer may be provided interposed between the monochromatic recording layers as already described.

The interlayer provided interposed between the monochromatic recording layers is mainly composed of a binder which may comprise additives such as hardener, polymer latex, filter dye, mica and ultraviolet absorber incorporated therein as necessary.

In an oil-in-water droplet dispersion method, the aforementioned filter dye is dissolved in one or a mixture of a high boiling solvent having a boiling point of 175° C. or more and a low boiling solvent having a boiling point of from 30° C. to 160° C. The solution is then finely dispersed in water or an aqueous solution of gelatin or polyvinyl alcohol in the presence of a surface active agent. As the aforementioned high boiling solvent there may be used a solvent disclosed in U.S. Pat. No. 2,322,027. Examples of the high boiling solvent and low boiling solvent employable herein include the same solvents as used in the preparation of the aforementioned microcapsule.

Specific examples of the step of polymer dispersion and curing and dipping latexes include those disclosed in U.S. Pat. No. 4,199,383, West German Patent Application Disclosure (OLS) 2,541,274 and 2,541,230, JP-A-49-74538, JP-A-51-59943 and JP-A-54-32552, and “Research Disclosure Vol. 148”, Item 14850, August 1976.

Preferred among these latexes are copolymer latexes of acid monomer such as acrylic acid esters and methacrylic acid esters such as ethyl acrylate, n-butyl acrylate, n-butyl methacrylate and 2-acetoacetoxyethyl methacrylate, acrylic acid and 2-acrylamide-2-methyl propanesulfonic acid.

—Other Components—

The various layers such as protective layer, photosensitive thermosensitive recording layer and interlayer constituting the two-photon absorption recording material each normally comprise a binder incorporated therein. As such a binder there may be used the same binder as used in the emulsion dispersion of the aforementioned photopolymerizable composition or the water-soluble polymer (further described later) to be used in the capsulization of the color-developable or color-extinguishable component. Besides these binder materials, solvent-soluble polymers such as acrylic resin, e.g., polystyrene, polyvinyl formal, polyvinyl butyral, polymethyl acrylate, polybutyl acrylate, polymethyl methacrylate, polybutyl methacrylate, copolymer thereof, phenolic resin, styrene-butadiene resin, ethyl cellulose epoxy resin and urethane resin, and polymer latexes thereof may be used. Preferred among these binder materials are gelatin and polyvinyl alcohol.

The various recording layers constituting the two-photon absorption recording material each may comprise various surface active agents incorporated therein for various purposes such as facilitation of spreading, prevention of static charging, improvement of slipperiness, emulsion dispersion and prevention of adhesion. Examples of the aforementioned surface active agents include nonionic surface active agents such as saponin and polyethylene oxide derivative (e.g., polyethylene oxide and alkyl ether of polyethylene oxide), anionic surface active agents such as alkylsulfonate, alkylbenzenesulfonate, alkylnaphthalenesulfonate, alkylsulfuric acid ester, N-acyl-N-alkyltauric acid, sulfosuccinic acid ester and sulfoalkylpolyoxyethylene alkylphenyl ether, amphoteric surface active agents such as alkylbetaine and alkylsulfobetaine, and cationic surface active agents such as aliphatic and aromatic quaternary ammonium salt and aromatic quaternary ammonium salt.

The various recording layers may comprise additives such as dye, ultraviolet absorber, plasticizer, fluorescent brightening agent, matting agent, coating aid, hardener, antistatic agent and slipperiness improver incorporated therein as necessary. For specific examples of these additives, reference can be made to “Research Disclosure”, Vol. 176, Item 17643, December 1978, and Vol. 187, Item 18716, November 1979.

The two-photon absorption recording material to be used in the invention preferably also has a hardener incorporated in the various layers such as photosensitive thermosensitive recording layer, interlayer and protective layer. It is particularly preferred that the protective layer comprise a hardener incorporated therein to lower the adhesivity thereof. As the aforementioned hardener there may be used a “gelatin hardener” for use in the production of photographic light-sensitive materials. Other examples of the hardener employable herein include aldehyde-based compounds such as formaldehyde and glutaraldehyde, reactive halogen compounds disclosed in U.S. Pat. No. 3,635,718, reactive compounds having ethylenically unsaturated group disclosed in U.S. Pat. No. 3,635,718, aziridine-based compounds disclosed in U.S. Pat. No. 3,017,280, halogenocarboxyaldehydes such a epoxy-based compound and mucochloric acid and dioxanes such as dihydroxydioxane and dichlorodioxane disclosed in U.S. Pat. No. 3,091,537, vinylsulfones disclosed in U.S. Pat. Nos. 3,642,486 and 3,687,707, vinylsulfone precursors disclosed in U.S. Pat. No. 3,841,872, and ketovinyls disclosed in U.S. Pat. No. 3,640,720. As inorganic hardeners there may be used chrome alum, zirconium sulfate, boric acid, etc.

Preferred among these compounds are 1,3,5-triacryloyl-hexahdydro-s-triazine, 1,2-bisvinyl sulfonylmethane, 1,3-bis(vinylsulfonylmethyl)propanol-2,bis(α-vinylsulfonylacetamide)ethane, 2,4-dichloro-6-hydroxy-s-triazine sodium salt, 2,4,6-triethylenamino-s-triazine, and boric acid. The amount of the aforementioned hardener to be incorporated in the layers is preferably from 0.5 to 5% by mass based on the amount of the binder used.

The two-photon absorption recording material of the invention can be prepared by optionally dissolving the aforementioned various components in a solvent to prepare a photosensitive thermosensitive recording layer coating solution, a protective layer coating solution, etc., and they spreading these coating solutions over desired supports on which they are then dried. Examples of the aforementioned solvent include water, alcohols such as methanol, ethanol, n-propanol, isopropanol, n-butanol, sec-butanol, methyl cellosolve and 1-methoxy-2-propanol, halogen-based solvents such as methylene chloride and ethylene chloride, ketones such as acetone, cyclohexanone and methyl ethyl ketone, esters such as methyl acetate, ethyl acetate and methyl acetate, toluene, and xylene. These solvents may be used singly or in admixture of two or more thereof. Particularly preferred among these solvents is water.

Examples of the coating means for spreading the photosensitive thermosensitive recording layer coating solution include blade coater, rod coater, knife coater, roll doctor coater, reverse roll coater, transfer roll coater, gravure coater, kiss roll coater, curtain coater, and extrusion coater. For the details of the spreading method, reference can be made to “Research Disclosure”, Vol. 200, Item 20036, Clause XV, December 1980. The thickness of the photosensitive thermosensitive recording layer is preferably from 0.1 μm to 50 μm, more preferably from 5 μm to 35 μm.

Examples of the support to be used in the two-photon absorption recording material of the invention include synthetic papers such as neutral paper, acidic paper, coated paper and laminated paper, films such as polyethylene terephthalate film, cellulose triacetate film, polyethylene film, polystyrene film and polycarbonate film, sheet of metal such as aluminum, zinc and copper, dried glass sheet, and support materials obtained by subjecting these support materials to various treatments such as surface treatment, undercoating and metal vacuum deposition. Support materials disclosed in “Research Disclosure”, Vol. 200, Item 20036, Clause XVII, December 1980 can also be used. The aforementioned various support materials may also comprise a fluorescent brightening agent, a bluing dye, a pigment, etc. incorporated therein.

In the case where a reflection-type two-photon absorption is prepared, the support to be used in the two-photon absorption recording material of the invention is preferably transparent. Preferred examples of the transparent support employable herein include polyethylene terephthalate film, cellulose triacetate film, polycarbonate film, and dried glass sheet,

If necessary, an antihalation layer may be provided interposed between the support and the photosensitive thermosensitive recording layer. A slippery layer, an antistatic layer, an anti-curling layer, an adhesive layer, etc, may be provided on the surface of the support (opposite the photosensitive thermosensitive recording layer). An adhesive layer may be provided interposed between the support and the photosensitive thermosensitive recording layer to form a seal type configuration such that the support is used as release paper.

In the case where an antihalation layer is provided between the support and the photosensitive thermosensitive recording layer or, in the case of transparent support on the surface of the support opposite the photosensitive thermosensitive recording layer, the antihalation layer may be of photo- or thermo-bleachable type.

In the case where a layer which can be bleached when irradiated with light is provided, a combination of the aforementioned spectral sensitizing dye and borate compound (combination of the spectral sensitizing dye and borate compound I or combination of the borate compound I and borate compound II) can be used. In the case where a heat-bleachable layer is provided, a configuration may be used in which heating causes the generation of a base or nucleophilic agent that can bleach the spectral sensitizing dye present therewith.

A layer of a polymer having a low oxygen permeability such as gelatin and polyvinyl alcohol (PVA) may be provided interposed between the support and the photosensitive thermosensitive recording layer. The provision of such a layer makes it possible to effectively inhibit the fading attributed to photooxidation of refractive index-, absorptivity or luminescence-modulated recording.

As mentioned above, the two-photon absorption recording material of the invention provides quite a new recording process that gives basic solution to the aforementioned problems, particularly gives satisfaction of both requirements for higher sensitivity and other properties, including good storage properties, dryability and higher recording density. The two-photon absorption recording material of the invention is preferably used particularly for optical recording media.

Further, the two-photon absorption recording material of the invention is preferably used for three-dimensional volume display, optical material, lens, security, etc. besides optical recording media.

The invention will be further described hereinafter, but the invention is not limited thereto. The term “parts” and “%” as used in the following examples are meant to indicate “parts by mass (pants by weight)” and “% by mass (% by weight)” respectively.

### EXAMPLE 1

### Example 1

### Preparation and Evaluation of Two-Photon Absorption Recording Material

<Preparation of Electron-Donating Colorless Dye-Containing Microcapsule Solution>

(1-a) Preparation of Electron-Donating Colorless Dye-Containing Microcapsule Solution (I)

8.9 g of the already exemplified yellow-developable electron-donating colorless dye (L-1) was dissolved in 16.9 g of ethyl acetate. To the solution were then added 20 g of a capsule wall material (trade name: Takenate D-110N, produced by Takeda Pharmaceutical Company Limited.) and 2 g of a capsule wall material (trade name: Millionate MR200, produced by NIPPON POLYURETHANE INDUSTRY CO., LTD.). The solution thus obtained was added to a mixture of 42 g of 8% phthalated gelatin and 1.4 g of 10% sodium dodecylbenzenesulfonate, and then emulsion-dispersed to obtain an emulsion. Subsequently, to the emulsion thus obtained were added 14 g of water and 72 g of a 2.9% aqueous solution of tetraethylene pentamine. The mixture was then heated to 60° C. with stirring for 2 hours to obtain a microcapsule solution (1) having an average particle diameter of 0.2 μm with the aforementioned electron-donating colorless dye (L-1) as core.

(1-b) Preparation of Electron-Donating Colorless Dye-Containing Microcapsule Solution (II)

The aforementioned method (1-a) was followed except that the following magenta-colorable electron-donating colorless dye (2) was used instead of the electron-donating colorless dye (L-1). Thus, a microcapsule solution (II) having an average particle diameter of 0.2 μm with the d electron-donating colorless dye (2) as core was obtained.

(1-c) Preparation of Electron-Donating Colorless Dye-Containing Microcapsule Solution (III)

The aforementioned method (1-a) was followed except that the following cyan-colorable electron-donating colorless dye (3) was used instead of the electron-donating colorless dye (L-1). Thus, a microcapsule solution (III) having an average particle diameter of 0.2 μm with the d electron-donating colorless dye (3) as core was obtained.

(1-d) Preparation of Dissociative Dye Dissociation Product-Containing Microcapsule Solution (IV)

The aforementioned method (1-a) was followed except that the already exemplified color-extinguishable dissociative dye dissociation product (G-23) which is a yellow dye was used instead of the electron-donating colorless dye (L-1). Thus, a microcapsule solution (IV) having an average particle diameter of 0.2 μm with the dissociative dye dissociation product (G-23) as core was obtained.

(1-e) Preparation of Dissociative Dye Dissociation Product-Containing Microcapsule Solution (V)

The aforementioned method (1-a) was followed except that the already exemplified color-extinguishable dissociative dye dissociation product (G-5) which is a magenta dye was used instead of the electron-donating colorless dye (L-1). Thus, a microcapsule solution (V) having an average particle diameter of 0.2 μm with the dissociative dye dissociation product (G-5) as core was obtained.

(1-f) Preparation of Cyanine Base-Containing Microcapsule Solution (VI)

The aforementioned method (1-a) was followed except that the following yellow-developable cyanine base (LC-10) was used instead of the electron-donating colorless dye (L-1). Thus, a microcapsule solution (VI) having an average particle diameter of 0.2 μm with the cyanine base (LC-10) as core was obtained.

(1-g) Preparation of Cyanine Base-Containing Microcapsule Solution (VII)

The aforementioned method (1-a) was followed except that the following magenta-developable cyanine base (LC-11) was used instead of the electron-donating colorless dye (L-1). Thus, a microcapsule solution (VII) having an average particle diameter of 0.2 μm with the cyanine base (LC-11) as core was obtained.

(1-h) Preparation of Cyanine Base-Containing Microcapsule Solution (VIII)

The aforementioned method (1-a) was followed except that the following cyan-developable cyanine base (LC-3) was used instead of the electron-donating colorless dye (L-1). Thus, a microcapsule solution (VIII) having an average particle diameter of 0.2 μm with the cyanine base (LC-3) as core was obtained.

<Preparation of Photopolymerizable Composition Emulsion>

(2-a) Preparation of Photopolymerizable Composition Emulsion (1)

5 g of the following electron-donating compound (1) having a polymerizable group was added to a mixture of 0.6 g of the already exemplified organic borate compound (29) (borate compound I), 0.1 g of the already exemplified spectral sensitizing dye-based borate compound (26) (borate compound II), the following auxiliary (1) for enhancing sensitivity and 3 g of isopropyl acetate (water solubility; about 4.3%). The solution thus obtained was then added to a mixture of 13 g of a 13% aqueous solution of gelatin, 0.8 g of the following 2% aqueous solution of surface active agent (1) and 0.8 g of the following 2% aqueous solution of surface active agent (2). The mixture was then subjected to emulsification at 10,000 rpm using a homogenizer (produced by Nippon Seiki Co., Ltd.) for 5 minutes to obtain a photopolymerizable composition emulsion (1). 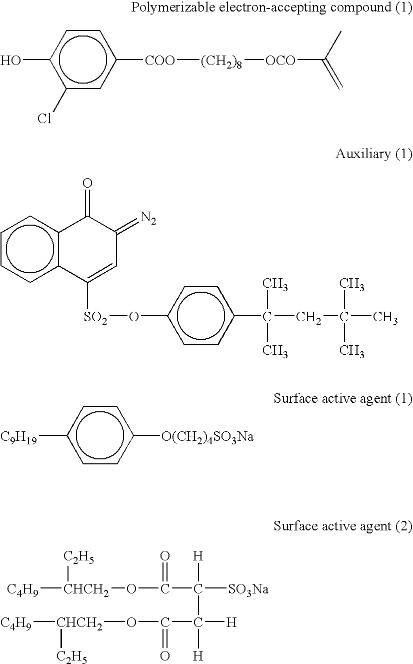
(2-b) Preparation of Photopolymerizable Composition Emulsion (2)

A photopolymerizable composition emulsion (2) was obtained in the same manner as in the method (2-a) except that 0.1 g of the already exemplified spectral sensitizing dye-based borate compound (28) (borate compound II) was used instead of the spectral sensitizing dye-based borate compound (26).

<Preparation of Photosensitive Thermosensitive Recording Layer Coating Solution>

(3-a) Preparation of Photosensitive Thermosensitive Recording Layer Coating Solution (1)—[Yellow Color Development]

4 g of the electron-donating colorless dye containing microcapsule solution (1), 12 g of the photopolymerizable composition emulsion (1) and 12 g of a 15% aqueous solution of gelatin were mixed to prepare a photosensitive thermosensitive recording layer coating solution (1).

(3-b) Preparation of Photosensitive Thermosensitive Recording Layer Coating Solution (2)—[YELLOW Color Extinction]

4 g of the dissociative dye dissociation product-containing microcapsule solution (IV), 12 g of the photopolymerizable composition emulsion (1) and 12 g of a 15% aqueous solution of gelatin were mixed to prepare a photosensitive thermosensitive recording layer coating solution (2).

(3-c) Preparation of Photosensitive Thermosensitive Recording Layer Coating Solution (3)—[Yellow Color Development]

4 g of the cyanine base-containing microcapsule solution (VI), 12 g of the photopolymerizable composition emulsion (1) and 12 g of a 15% aqueous solution of gelatin were mixed to prepare a photosensitive thermosensitive recording layer coating solution (3).

(3-d) Preparation of Photosensitive Thermosensitive Recording Layer Coating Solution (4)—[Magenta Color Development]

4 g of the electron-donating colorless dye-containing microcapsule solution (II), 12 g of the photopolymerizable composition emulsion (2) and 12 g of a 15% aqueous solution of gelatin were mixed to prepare a photosensitive thermosensitive recording layer coating solution (4).

(3-e) Preparation of Photosensitive Thermosensitive Recording Layer Coating Solution (5)—[Magenta Color Extinction]

4 g of the dissociative dye dissociation product-containing microcapsule solution (V), 12 g of the photopolymerizable composition emulsion (2) and 12 g of a 15% aqueous solution of gelatin were mixed to prepare a photosensitive thermosensitive recording layer coating solution (5).

(3-f) Preparation of Photosensitive Thermosensitive Recording Layer Coating Solution (6)—[Magenta Color Development]

4 g of the cyanine base-containing microcapsule solution (VII), 12 g of the photopolymerizable composition emulsion (2) and 12 g of a 15% aqueous solution of gelatin were mixed to prepare a photosensitive thermosensitive recording layer coating solution (6).

(3-g) Preparation of Photosensitive Thermosensitive Recording Layer Coating Solution (7)—[Cyan Color Development]

4 g of the electron-donating colorless dye-containing microcapsule solution (III), 12 g of the photopolymerizable composition emulsion (2) and 12 g of a 15% aqueous solution of gelatin were mixed to prepare a photosensitive thermosensitive recording layer coating solution (7).

(3-h) Preparation of Photosensitive Thermosensitive Recording Layer Coating Solution (7)—[Cyan Color Development]

4 g of the cyanine base-containing microcapsule solution (VIII), 12 g of the photopolymerizable composition emulsion (2) and 12 g of a 15% aqueous solution of gelatin were mixed to prepare a photosensitive thermosensitive recording layer coating solution (8).

<Preparation of Inventive Two-Photon Absorption Recording Materials 101 to 108>

The aforementioned photosensitive thermosensitive recording layer coating solution (1) was spread over a cellulose triacetate (TAC) having a thickness of 200 μm to a dried thickness of about 20 μm, and then dried to obtain a photosensitive thermosensitive two-photon absorption recording material (101). The aforementioned method was followed except that the aforementioned photosensitive thermosensitive recording layer coating solution (1) was replaced by the aforementioned photosensitive thermosensitive recording layer coating solutions (2) to (8). Thus, photosensitive thermosensitive two-photon absorption recording materials 102 to 108 wore obtained, respectively.

<Evaluation of Two-Photon Recording/Reproduction>

For the evaluation of the performance of the two-photon absorption recording materials 104 to 108 of the invention, a Ti:sapphire pulse laser allowing measurement at a wavelength of from 700 nm to 1,000 nm (pulse width: 100 fs; frequency: 80 MHz; average output: 1 W; peak power: 100 kW) was used. The two-photon absorption recording materials were each irradiated with light beam obtained by condensing the laser light through NA0.6 lens (first step). The samples having a latent image formed thereon were each then heated over a 120° C. hot plate for 5 seconds (second step). The samples were each then irradiated with light beam having a wavelength of from 550 nm to 650 nm on the entire surface thereof so that the recorded area was fixed while the color of the spectral sensitizing dye was extinguished (third step).

For the evaluation of the performance of the two-photon absorption recording materials 101 to 103 of the invention, two-photon absorption was similarly effected using a 660 nm semiconductor laser for DVD (output: 200 mW) (first step). The samples having a latent image formed thereon were each then heated over a 120° C. hot plate for 5 seconds (second step). The samples were each then irradiated with light beam having a wavelength of from 450 nm to 550 nm on the entire surface thereof so that the recorded area was fixed while the color of the spectral sensitizing dye was extinguished (third step).

As a result, all the samples 101 to 108 were observed to show color development or color extinction at the laser-focused portion on the irradiated area (recorded area), The change of the absorptivity of the recorded area and the non-recorded area (unfocused portion) were visually confirmed using an optical microscope. The refractive index of the recorded area was measured. As a result, the recorded area showed a refractive index rise from that of the non-recorded area in the color development system (Samples 101, 103, 104, 106 to 108) and a refractive index drop from that of the non-recorded area in the color extinction system (Samples 102, 105). When Samples 101 to 108 were each irradiated with laser light having a wavelength of 780 nm at which the color-developable or color-extinguishable dye shows no absorption using a reflective confocal microscope, it was then confirmed that the difference in refractive index between the recorded area and the non-recorded area makes some difference in reflectance.

Samples 101 to 108 having data recorded thereon were each irradiated with laser light having a wavelength at which the color-developable or color-extinguishable dye shows absorption using a transmission type confocal microscope. As a result it was confirmed that there is some difference in transmittance due to difference in absorptivity between the recorded area and the non-recorded area.

Samples 104 to 108 were also confirmed to have some difference in luminescence intensity.

By scanning the laser-focused point in the horizontal and depth directions, color development or color extinction was allowed to occur in arbitrary positions in the three-dimensional direction. Three-dimensional reflectance modulation due to refractive index modulation by the irradiation with laser light having a wavelength of 780 nm at which the color-developable or color-extinguishable dye shows no absorption was confirmed possible. Three-dimensional transmittance modulation or three-dimensional luminescence intensity modulation due to absorptivity modulation by the irradiation with laser light having a wavelength at which the color-developable or color-extinguishable dye shows absorption was confirmed possible.

Further, Samples 101 to 108 having data recorded thereon were confirmed to allow reproduction even after 2 weeks of aging under fluorescent lamp and thus were confirmed to be excellent in storage properties against light.

The same effects were exerted also when the electron-donating colorless dye to be used in Sample 101 of the invention was replaced by LC-2, when the electron-donating colorless dye to be used in Sample 104 of the invention was replaced by L-6 or when the electron-donating colorless dye to be used in Sample 107 of the invention was replaced by L-4, L-5, L-8, L-9 or L-12.

The same effects were exerted also when the dissociative dye dissociation product to be used in Sample 102 of the invention was replaced by G-1, G-3, G-7, G-17, G-18 or G-22 or when the dissociative dye dissociation product to be used in Sample 105 of the invention was replaced by G-2, G-4, G-6, G-8 or G-14.

The same effects were exerted also when the cyanine base to be used in Sample 103 of the invention was replaced by LC-1, when the cyanine base to be used in Sample 106 of the invention was replaced by LC-2, LC-8, LC-13, LC-14 or LC-15 or when the cyanine base to be used in Sample 108 of the invention was replaced by LC-12 or LC-15.

The same effects were exerted also when the photopolymerization initiator containing a spectral sensitizing dye (two-photon absorption compound) to be used in the two-photon absorption recording materials 101 to 108 were replaced by the photopolymerization initiators (34), (42), (44) and (45), respectively.

While the invention has been described in detail mid with reference to specific embodiments thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, if fully set forth herein.

What is claimed is:

1. A two-photon recording method comprising the steps of:
a first step of forming a latent image in a two-photo absorption recording material by two-photon absorption;
a second step of subjecting the two-photon absorption recording material having the latent image to heat treatment so as to record a modulation of a refractive index, absorptivity or luminescence intensity in the two-photon absorption recording material in accordance with the latent image; and
a third step of irradiating the two-photon absorption recording material entirely with light to fix the modulation,
wherein a record can be reproduced based on the modulation without erasing the modulation.

2. The two-photon recording method according to claim 1, wherein a light source in the two-photon absorption of the first step is a laser.

3. The two-photon recording method according to claim 1, wherein a light source in the irradiating of the third step is at least one selected from the group consisting of a laser, an LED, a flash lamp, a fluorescent lamps a xenon lamp and a mercury vapor lamp.

4. The two-photon recording method according to claim 1, wherein the two-photon absorption recording material comprises a photopolymerizable composition, the photopolymerizable composition comprising: a photopolymerizable compound having an ethylenically unsaturated bond; and a photopolymerization initiator.

5. The two-photon recording method according to claim 1, wherein the two-photon absorption recording material comprises a support and a photosensitive and thermosensitive recording layer comprising a photopolymerizable composition, the photopolymerizable composition comprising:
a thermo-responsive microcapsule containing a component A therein, the component A being one of a color-developable component and a color-extinguishable component;
a compound B that is substantially colorless, the compound B comprising, In the same molecule of the compound B, an ethylenically unsaturated bond and a site that reacts with the component A to cause color development or color extinction of the component A; and
a photopolymerizable initiator,
and wherein
the photopolymerizable composition is subjected to the two-photon absorption at the first step to form the latent image,
the heat treatment at the second slap causes color development or color extinction of the component A in accordance with the latent image to record the modulation of the refractive index, absorptivity or luminescence intensity, and
the photosensitive and thermosensitive recording layer is irradiated entirely with light at the third step to decolor the photopolymerization initiator so that the modulation is fixed.

6. The two-photon recording method according to claim 1, wherein the two-photon absorption recording material comprises a support and a photosensitive and thermosensitive recording layer comprising a photopolymerizable composition, the photopolymerizable composition comprising:
a thermo-responsive microcapsule containing a component A therein, the component A being one of a color-developable component and a color-extinguishable component;
a component C that is substantially colorless and reacts with the component A to cause color development or color extinction of the component A;
a compound D comprising, in the same molecule of the compound B, an ethylenically unsaturated bond and a site that inhibits a reaction of the component C with the component A; and
a photopolymerizable initiator,
and wherein
the photopolymerizable composition is subjected to the two-photon absorption at the first step to form the latent image,
the heat treatment at the second stop causes color development or color extinction of the component A in accordance with the latent image to record the modulation of the refractive index, absorptivity or luminescence intensity, and
the photosensitive and thermosensitive recording layer is irradiated entirely with light at the third step to decolor the photopolymerization initiator so that the modulation is fixed.

7. The two-photon recording method according to claim 4, wherein the photopolymerization initiator comprises: a spectral sensitizing dye having a maximum absorption wavelength of 300 nm to 800 nm: and a compound interacting with the spectral sensitizing dye.

8. The two-photon recording method according to claim 7, wherein the spectral sensitizing dye is a compound undergoing two-photon absorption.

9. The two-photon recording method according to claim 7, wherein the two-photon absorption is induced by irradiating the two-photon absorption recording material with laser light having a longer wavelength than a linear absorption band of the spectral sensitizing compound which undergoes two-photon absorption; and a linear absorption molar absorptivity of 10 or less.

10. The two-photon recording method according to claim 7, wherein the compound interacting with the spectral sensitizing dye comprises an organic borate compound.

11. The two-photon recording method according to claim 1, wherein the record is non-rewritable.

12. The two-photon recording method according to claim 1 wherein the two-photon absorption recording material comprises a plurality of recording layers.

13. A two-photon absorption recording material comprising: a support; and a two-photon absorption recording layer, wherein a recording in the two-photon absorption recording material is performed by a two-photo recording method according to claim 1.

14. A two-photon absorption recording-reproduction method comprising irradiating a recording material, in which a modulation of a refractive index or absorptivity of the recording material is recorded by a two-photon recording method according to claim 1, with light to detect a difference in reflectance or transmittance of the recording material.

15. A two-photon absorption recording-reproduction method comprising irradiating a recording material, in which a modulation of a relive index or absorptivity of the recording material is recorded by a two-photon recording method according to claim 1, with light to detects difference in luminescence intensity of the recording material.

16. A three-dimensional optical recording medium comprising a two-photon absorption recording material according to claim 13.

17. The three-dimensional optical recording medium according to claim 16, wherein the two-photon absorption recording material is stored in a light-screening cartridge during storage.

18. The two-photon recording method according to claim 1, which is for a three-dimensional recording.

19. The two-photon absorption recording material according to claim 13, which is for a three-dimensional volume display.

20. The two-photon recording material according to claim 1, which is for recording a three-dimensional volume display.
